(19) United States
(12) Patent Application Publication
(10) Pub. No.: US 2026/0178346 A1
(43) Pub. Date: Jun. 25, 2026

(54) GENERATIVE WIDGET FRAMEWORK SYSTEM, PATTERNS, AND PRINCIPLES

(71) Applicant: Google LLC, Mountain View, CA (US)

(72) Inventors: Matthew Sibigtroth, Urbana, IL (US); Bradley E. Geilfuss, JR., Campbell, CA (US); Anders Johan Prag, Redmond, WA (US); Ishac Bertran, Brooklyn, NY (US); Michael Ichihashi Guss, Seattle, WA (US); Seth Ryan Benson, Emeryville, CA (US); Gaetano Ling, Mountain View, CA (US); Kevin Gaunt, San Francisco, CA (US); Xiaoxuan Wang, Santa Clara, CA (US); Michael Digman Morrino, Mountain View, CA (US)

(21) Appl. No.: 19/423,833

(22) Filed: Dec. 17, 2025

Related U.S. Application Data
(60) Provisional application No. 63/736,382, filed on Dec. 19, 2024.

(51) Int. Cl. G06F 9/445; G06F 9/451

(52) U.S. Cl. CPC G06F 9/44505; G06F 9/451

(57) ABSTRACT

An example computing system retrieves, using an application programming interface, information from one or more applications, and generates, based on at least a portion of the information, personal context information for a user. Responsive to receiving an indication of a natural language request to generate at least one graphical component, the computing system applies a machine learning model to the indication of the natural language request to determine at least one user intent. The computing system generates, using one or more of the information from the one or more applications and the personal context information for the user, a set of instructions including instructions for generating the at least one graphical component, e.g., a widget based on the at least one user intent.

### CROSS REFERENCE TO RELATED APPLICATION

This application claims the benefit of U.S. Provisional Patent Application No. 63/736,382 filed Dec. 19, 2024, which is incorporated by reference herein in its entirety.

### BACKGROUND

Applications executed on computing devices may provide a wide variety of functionality to users, which may help them perform various tasks. However, users must typically interact with multiple user interface elements and/or screens of multiple applications before they are able to access such functionality and complete such tasks. Furthermore, users may find it challenging and/or time-consuming to navigate through entire applications, and may find it difficult to complete tasks due to information being stored across multiple different applications.

### SUMMARY

In general, aspects of this disclosure are directed to techniques for applying a large language model to natural language input to determine user intent and to generate custom graphical components (e.g., “widgets”) based on the user intent. An example computing system may retrieve, using an application programming interface (API), information from one or more applications, such as a banking application, web browser application, or any other application that might be installed at a user computing device (e.g., a mobile phone). In some examples, the information may be retrieved from a device settings application. The computing system may generate, based on at least a portion of the information, context information for a user. For example, the computing system may apply a machine learning model (e.g., a large language model) to the portion of the information to infer one or more user preferences, such as user preferences for accessibility, display settings, etc. In some examples, the computing system may infer user preferences such as preferred applications for performing certain tasks, preferences that are based on personal user data (e.g., a user prioritizes responding to messages received from family members over other received messages), etc. In general, responsive to receiving an indication of a natural language request to generate at least one graphical component (e.g., a user providing a natural language input such as, “Create a widget that only shows me texts received from important people.”), the computing system may apply the machine learning model to the indication of the nature language request to determine at least one user intent. Then, the computing system may generate, using one or more of the information from the one or more applications and the context information for the user, a set of instructions including instructions for generating the at least one widget based on the user intent. In some examples, the generated widget may provide functionality required to satisfy the at least one user intent.

In one example, the disclosure is directed toward a method that includes retrieving, by a computing system, and using an application programming interface, information from one or more applications, and generating, by the computing system, and based on at least a portion of the information, context information for a user. The method further includes, responsive to receiving an indication of a natural language request to generate at least one graphical component, applying, by the computing system, a machine learning model to the indication of the natural language request to determine at least one user intent. The method further includes generating, by the computing system, and using one or more of the information from the one or more applications and the context information for the user, a set of instructions including instructions for generating the at least one graphical component based on the at least one user intent.

In another example, the disclosure is directed toward a computing system comprising one or more processors, and one or more storage devices that store instructions. The instructions, when executed by the one or more processors, cause the one or more processors to retrieve, using an application programming interface, information from one or more applications, and generate, based on at least a portion of the information, context information for a user. The instructions further cause the one or more processors to, responsive to receiving an indication of a natural language request to generate at least one graphical component, apply a machine learning model to the indication of the natural language request to determine at least one user intent. The instructions further cause the one or more processors to generate, using one or more of the information from the one or more applications and the context information for the user, a set of instructions including instructions for generating the at least one graphical component based on the at least one user intent.

In another example, the disclosure is directed toward a non-transitory computer-readable storage medium encoded with instructions that, when executed by one or more processors, cause one or more processors to retrieve, using an application programming interface, information from one or more applications, and generate, based on at least a portion of the information, context information for a user. The instructions further cause the one or more processors to, responsive to receiving an indication of a natural language request to generate at least one graphical component, apply a machine learning model to the indication of the natural language request to determine at least one user intent. The instructions further cause the one or more processors to generate, using one or more of the information from the one or more applications and the context information for the user, a set of instructions including instructions for generating the at least one graphical component based on the at least one user intent.

In another example, the disclosure is directed toward a computer program product for generating custom graphical components for generating custom graphical components. The computer program product comprises instructions that, when executed by one or more processors, cause the one or more processors to retrieve, using an application programming interface, information from one or more applications, and generate, based on at least a portion of the information, context information for a user. The instructions further cause the one or more processors to, responsive to receiving an indication of a natural language request to generate at least one graphical component, apply a machine learning model to the indication of the natural language request to determine at least one user intent. The instructions further cause the one or more processors to generate, using one or more of the information from the one or more applications and the context information for the user, a set of instructions including instructions for generating the at least one graphical component based on the at least one user intent.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing system for dynamically generating custom graphical components, in accordance with one or more techniques of this disclosure.

FIG. 2 is a block diagram illustrating another example computing system configured to apply a machine learning module to retrieved information to dynamically generate custom graphical components, in accordance with one or more techniques of this disclosure.

FIG. 3A is a conceptual diagram illustrating an example training process for a machine learning module, in accordance with one or more techniques of this disclosure.

FIG. 3B is a conceptual diagram illustrating an example trained machine learning module, in accordance with one or more techniques of this disclosure.

FIG. 3C is a conceptual diagram illustrating a machine learning module configured to parse natural language input to identify user intent, in accordance with one or more techniques of this disclosure.

FIGS. 4A-4B are conceptual diagrams illustrating examples of custom graphical components, in accordance with one or more techniques of this disclosure.

FIG. 5 is a flowchart illustrating an example operation for dynamically generating custom graphical components, in accordance with one or more techniques of this disclosure.

### DETAILED DESCRIPTION

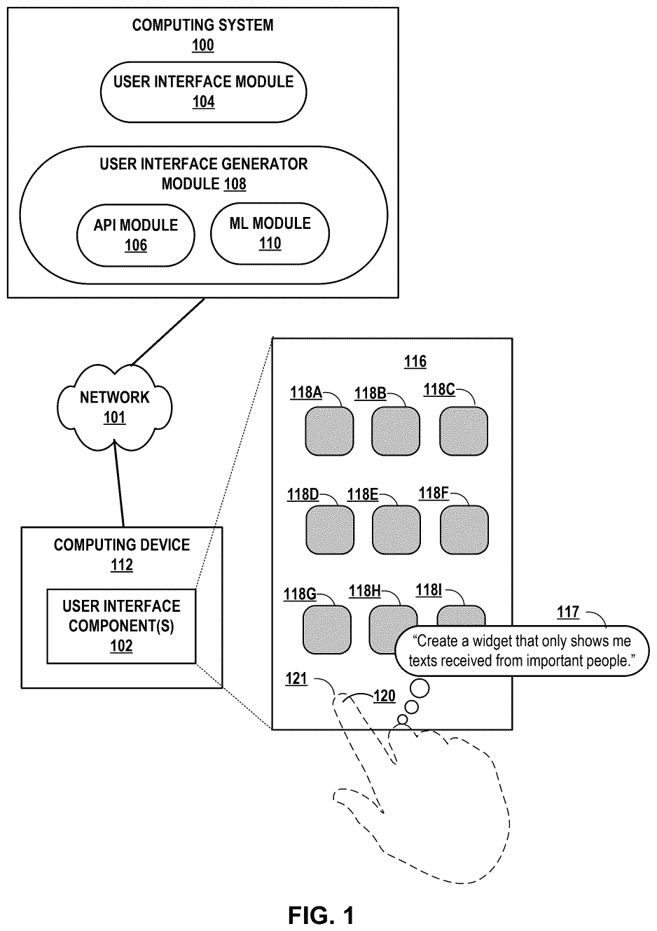

FIG. 1 is a conceptual diagram illustrating an example computing system for dynamically generating custom graphical components, in accordance with one or more techniques of this disclosure. In the example of FIG. 1, a user 120 interacts with computing device 112 that is in communication with computing system 100. In some examples, some or all of the components and/or functionality attributed to computing system 100 may be implemented or performed by computing device 112.

In some examples, computing system 100 may be implemented on a plurality of computing devices that may include, but are not limited to, portable, mobile, or other devices, such as mobile phones (including smartphones), laptop computers, desktop computers, tablet computers, smart television platforms, server computers, mainframes, etc. In some examples, computing system 100 may represent a cloud computing system that provides one or more services via network 101. That is, in some examples, computing system 100 may be a distributed computing system.

In examples in which computing system 100 may be a distributed system, such as in the example of FIG. 1, computing system 100 may communicate with computing device 112 via network 101. Network 101 may include any public or private communication network, such as a cellular network, Wi-Fi network, a direct cell-to-satellite communication network, or other type of network for transmitting data between computing system 100 and computing device 112. In some examples, network 101 may represent one or more packet switched networks, such as the Internet. Computing device 112 may send and receive data to and from computing system 100 across network 101 using any suitable communication techniques. For example, computing system 100 and computing device 112 may each be operatively coupled to network 101 using respective network links. Network 101 may include network hubs, network switches, network routers, etc., that are operatively inter-coupled thereby providing for the exchange of information between computing device 112 and computing system 100. In some examples, network links of network 101 may be Ethernet, ATM or other network connections. Such connections may include wireless and/or wired connections.

As shown in the example of FIG. 1, computing device 112 includes one or more user interface (UI) components (“UI components 102”). UI components 102 of computing device 112 may be configured to function as input devices and/or output devices for computing device 112. UI components 102 may be implemented using various technologies. For instance, UI components 102 may be configured to receive input from user 120 through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone or any other type of device for detecting a command from user 120. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UI components 102 of computing device 112 may include a presence-sensitive device that may receive tactile input from user 120. UI components 102 may receive indications of the tactile input by detecting one or more gestures from user 120 (e.g., when user 120 touches or points to one or more locations of UI components 102 with a finger or a stylus pen).

UI components 102 may additionally or alternatively be configured to function as an output device by providing output to user 120 using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to user 120. Additional examples of an output device include a speaker, a haptic device, or other device that can generate intelligible output to a user. For instance, UI components 102 may present output to user 120 as a graphical user interface that may be associated with functionality provided by computing device 112. In this way, UI components 102 may present various user interfaces of applications executing at or accessible by computing device 112 (e.g., an electronic message application, an Internet browser application, etc.). User 120 may interact with a respective user interface of an application to cause computing device 112 to perform operations relating to a function provided by the application.

In some examples, UI components 102 of computing device 112 may detect two-dimensional and/or three-dimensional gestures as input from user 120. For instance, a sensor of UI components 102 may detect the user's movement (e.g., moving a hand, an arm, a pen, a stylus, etc.) within a threshold distance of the sensor of UI components 102. UI components 102 may determine a two- or three-dimensional vector representation of the movement and correlate the vector representation to a gesture input (e.g., a hand-wave, a pinch, a clap, a pen stroke, etc.) that has multiple dimensions. In other words, UI components 102 may, in some examples, detect a multidimensional gesture without requiring the user to gesture at or near a screen or surface at which UI components 102 output information for display. Instead, UI components 102 may detect a multi-dimensional gesture performed at or near a sensor which may or may not be located near the screen or surface at which UI components 102 output information for display.

In the example of FIG. 1, computing system 100 includes user interface (UI) module 104. UI module 104 may perform operations described herein using hardware, software, firmware, or a mixture thereof residing in and/or executing at computing system 100. Computing system 100 may execute UI module 104 with one processor or with multiple processors. In some examples, computing system 100 may execute UI module 104 as a virtual machine executing on underlying hardware. UI module 104 may execute as one or more services of an operating system or computing platform or may execute as one or more executable programs at an application layer of a computing platform.

UI module 104, as shown in the example of FIG. 1, may be operable by computing system 100 to perform one or more functions, such as receive input and send indications of such input to other components associated with computing system 100. UI module 104 may also receive data from components associated with computing system 100. Using the data received, UI module 104 may cause other components associated with computing system 100, such as UI components 102, to provide output based on the data. For instance, UI module 104 may send data to UI components 102 of computing device 112 to display a GUI, such as GUI 116.

In general, user 120 may be provided with an opportunity to provide input to control whether programs or features of computing device 112 and/or computing system 100 can collect and make use of user information (e.g., user 120's personal data, information about user 120's current location, location history, activity, etc.), or to dictate whether and/or how computing device 112 and/or computing system 100 may receive content that may be relevant to user 120, such as user information retrieved from one or more applications installed at computing device 112. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 112 and/or computing system 100 so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, user 120 may have control over how information is collected about them and used by computing device 112 and/or computing system 100. For example, user 120 may be prompted by computing device 112 to provide explicit consent for computing device 112 and/or computing system 100 to retrieve and/or store any or all of user 120's data, including the context information described herein. In some examples, an action log executed on computing device 112 may provide user 120 a ledger of activity, which may show any automations or applications running in the background of computing device 112, as well as an accurate log of all UI generator module 108 activity.

In the example of FIG. 1, graphical user interface (GUI) 116 may be an example representation of a mobile phone home screen. GUI 116 may include a plurality of user interface elements and/or user interface components. For example, as shown in FIG. 1, GUI 116 includes user interface components 118A-118I, which may be referred to as “widgets” and may be referred to herein collectively as “widgets 118.” In general, a widget may be a smaller GUI or GUI element that provides specific functionality or access to a larger application. One or more applications may be installed and may execute at computing device 112. For example, some example applications may be a banking application, a calendar application, a messaging application, a web browser application, etc. As such, computing device 112 may include one or more applications, in which the one or more applications may be accessed via one or more widgets displayed on GUI 116, such as one or more of widgets 118A-118I.

In general, an application from the one or more applications may include information, e.g., data, instructions, etc., that can be retrieved by computing system 100, e.g., via API module 106. In general, an application from the one or more applications may include one or more functions. The one or more functions may refer to functions, or functionality, e.g., capabilities or features, that are provided by the values, settings, or other data that are directly embedded into the source code of the application, rather than those that are dynamically generated or configurable at runtime. An application may include functionality provided by values, logic, etc. that are fixed, e.g., “code logic,” in an application's source code, and cannot be easily changed without modifying the code itself. The one or more functions may be considered statically defined functions, or functions that are predefined at compile time or build time and do not change during execution. As such, an example widget on GUI 116 that “provides the functionality of an application” may be considered a graphical component that is generated based on and/or provides the statically defined capabilities or features of the application.

In general, computing system 100 may retrieve, e.g., via API module 106, information from the one or more applications installed on computing device 112. In some examples, the information may be retrieved from a device settings application. Thus, in general, the information retrieved by API module 106 may include system-level information (e.g., parameters and configurations that govern how a device operates, such as Wi-Fi, display brightness, notifications settings, etc.), and/or application-level information (e.g., user preferences for applications, functional data specific to the operations or state of an application, information associated with application functionality, etc.).

In some examples, an application may include an API that enables external applications or modules to interact with and use the data stored by the application. As such, API module 106 may receive information from the one or more applications, e.g., an API response. As an example, a banking application may include predefined or statically defined functionality for a button that a user may interact with to have funds transferred from their bank account. API module 106 may use the banking application API to retrieve the information associated with the banking application's functions, which may include, for example, instructions for generating the button UI, and a value for the current balance of the user's bank account, but may not include all of the predefined or statically defined functionality or logic for determining and displaying the value for the current balance of the user's bank account.

As such, the one or more applications may be considered to include a plurality of predefined functions. For example, a calculator application may include predefined functionality for performing various arithmetic and mathematical operations, a browser application may include predefined functionality for accessing and browsing the Internet, a banking application may include predefined functionality for transferring funds, etc. As such, many applications executed on computing devices may include predefined functionality for performing various tasks, such as responding to messages, scheduling appointments, booking reservations, browsing the Internet, etc. However, some users may prefer that certain applications have better “shortcuts” for completing tasks, may prefer “shortcuts” to various information, and/or may prefer a more user-friendly experience when operating their personal devices. As an example, a user may receive dozens of text messages each day, some of which may be spam messages or unimportant to the user. Rather than having to navigate through the messages application, and/or review all of the received messages to determine which ones to respond to, a user may wish to have a custom widget on their home screen that displays messages from contacts the user deems important, e.g., family members. As such, users may prefer custom GUIs and graphical components that are more tailored to their personal life and preferences when operating their own devices.

As such, in general, one or more of widgets 118 may be considered a “custom” widget. In accordance with techniques of this disclosure, computing system 100 may include a user interface generator module 108 configured to dynamically generate custom graphical components based on user intent. In the example of FIG. 1, user 120 may provide a natural language input, e.g., a request to create a custom widget, and user interface generator module 108 may receive an indication of the natural language input and generate, using one or more of the information from the one or more applications and context information for user 120, instructions for generating the custom widget to satisfy the user's request (e.g., the custom widget may provide functionality, display information, or perform other functions such that a user's request may be fulfilled).

As shown in the example of FIG. 1, user interface generator module 108 includes API module 106 and machine learning (“ML”) module 110. In general, with explicit consent from user 120, user interface generator module 108 may run continuously and be configured to monitor the content of one or more applications and/or user activity. For example, with explicit consent from user 120, user interface generator module 108 may run continuously in the background of computing device 112 and be configured to monitor the content of one or more applications executing at computing device 112 (e.g., in the background and/or foreground of computing device 112) and/or user activity within computing device 112. As such, API module 106 receives explicit consent from user 120 to gather information from user 120 and the one or more applications installed at computing device 112. In general, user interface generator module 108 may continuously retrieve and analyze context information from computing device 112, again provided that user 120 has given explicit permission for computing system 100 to do so.

In general, API module 106, which can be considered an API library, may include multiple APIs that can be used to access one or more application APIs. In some examples, API module 106 may provide information about user interface elements, events, and actions to assistive technologies (e.g., screen readers, magnification gestures, switch devices, etc.) provided by computing system 100 and/or computing device 112. In some examples, API module 106 may be configured to enable the exchanging of data in a standardized format. For example, API module 106 may support REST (Representational State Transfer), which is a widely-used architectural style for building APIs that use HTTP (Hypertext Transfer Protocol) to exchange data between applications.

In general, with explicit consent from a user, computing system 100 may retrieve, using API module 106, information from one or more applications, systems, modules, files, data stores, cloud services, etc. included in and/or associated with computing system 100, and/or included in and/or associated with computing device 112 in communication with computing system 100. For example, the information may be retrieved from one or more installed applications, operating system(s), hardware modules, system settings and preferences, system logs and diagnostic tools, configuration files, metadata, associated cloud services, and the like. As such, the retrieved “information” (retrieved with explicit user consent) described herein may refer to various types of information that provide context for how, where, when, and why a user may interact with a computing device. That is, the retrieved “information” may include, but is not limited to, application data, application usage data, application permissions, application metadata, user data, historical user data, user preference data, user feedback data, location data, system data, environmental data, time data (e.g., when data is received by an application, timestamped data, etc.), event data, notification data (e.g., notifications generated by an application), security data, device data, device metadata, network information, connectivity information, device battery data, sensor data, and the like. For example, the retrieved context information may include data pertaining to messaging data, calendar invites, birthdays, special events, user notes, news, weather, stocks, traffic, and the like that may be relevant to a user. In some examples, information may be retrieved by computing system 100 continuously or periodically. In some examples, the information may be retrieved during a period of time in which the user is away from their device (e.g., the device was turned off, the user was sleeping, etc.). That is, in some examples, the computing device may be in an “active state,” in which a user is actively interacting with the computing device, or in an “inactive state,” in which the user is not actively interacting with the computing device. In some examples, the retrieved information may include data that pertains to a time period in which the computing device was in an inactive state, e.g., data for application notifications that the user received while sleeping.

In some examples, API module 106 may be configured to generate a stream of accessibility events as the user interacts with computing device 112 and applications executed on computing device 112. In some examples, these events may represent actions and changes in a user interface, such as button presses, text changes, and screen transitions. With explicit consent from user 120, user interface generator module 108 may receive and analyze these events to better understand how user 120 interacts with applications installed on computing device 112.

API module 106 may be configured to retrieve accessibility actions from applications executed on computing device 112. “Accessibility actions” may refer to different types of inputs that can be detected at a location associated with a UI component 102, such as mechanical inputs (e.g., a clicking of a button, a swiping of a screen, etc.), audio input (e.g., verbal command), or gesture control (e.g., triple tapping on a screen, hand wave, assistive gestures, etc.). As such, accessibility actions may provide users the ability to interact with an application or user interface element in multiple ways according to their needs. In some examples, with explicit consent from user 120, computing system 100 may determine which accessibility actions are frequently performed by user 120 when interacting with a GUI or application such that new user interfaces and graphical components generated by user interface generator module 108 can be better tailored for user 120's needs. In some examples, the information retrieved by API module 106 from computing device 112 may be stored by computing system 100 to identify potential accessibility issues and/or better understand how user 120 interacts with computing device 112. In some examples, user interface generator module 108 may use information retrieved from computing device 112 to determine the format, size, color scheme, accessibility features, or any other features to include in the instructions (e.g., code) for generating new graphical user interfaces and/or components. In some examples, user interface generator module 108 may also provide users the ability to configure various accessibility and/or display options according to their needs. For example, user 120 may be able to adjust the user interface elements of a GUI, such as text size, enable color correction, set up magnification gestures, and configure gesture-based navigation.

In some examples, the information retrieved by API module 106 includes application data, such as a set of instructions (e.g., code, data, information, etc.) associated with one or more functions (e.g., application functionality). The information may include user data, such as user account data, information relating to user actions performed within an application, etc. The information may include system data, environmental data, time data (e.g., when data is received by an application, timestamped data, etc.), event data, notification data (e.g., notifications generated by an application), security data, application and/or device metadata, etc. As an example, the retrieved information may indicate a message was received from a certain contact by a messaging application. In some examples, the retrieved information may be pre-processed by computing system 100. In some examples, the retrieved information may be in a data format that can be parsed by a machine learning model, such as a language model (e.g., the data may be in a structured or semi-structured data format).

In general, user interface generator module 108 may send information (e.g., the retrieved information) to machine learning module 110 only if computing system 100 receives permission from the user of computing device 112 to send the information. For example, in situations discussed in which computing system 100 and/or computing device 112 may collect, transmit, or may make use of personal information about a user (e.g., location information, financial information, etc.), the user may be provided with an opportunity to control whether programs or features of computing system 100 can collect user information (e.g., information about a user's social network, a user's social actions or activities, a user's profession, a user's preferences, or a user's current location), or to control whether and/or how computing system 100 and/or computing device 112 may store and share user information. Thus, the user may have control over how information is collected about the user and stored, transmitted, and/or used in accordance with techniques of this disclosure.

In general, computing system 100 may generate, based on at least a portion of the information retrieved by API module 106, context information for user 120. That is, in general, with explicit user consent, may generate and store a “personal memory” for the user that is indicative of user data, preferences, behavior, etc. In some examples, computing system 100 may apply machine learning module 110, which may include a large language model, to the portion of the information retrieved by API module 106 to infer one or more user preferences, such as user preferences for accessibility, display settings, etc. In some examples, machine learning module 110 may infer user preferences such as preferred applications for performing certain tasks, preferences that are based on personal user data (e.g., a user prioritizes responding to messages received from family members over other received messages), etc. In some examples, machine learning module 110 may infer other information, such as which contacts are associated with family members of the user (e.g., based on last name), etc. Computing system 100 may store this context information in a memory for future use.

In the example of FIG. 1, user 120 may provide natural language request 117 that includes a spoken request such as, “Create a widget that only shows me texts received from important people.” In some examples, the indication of natural language request 117 may be received in response to at least one gesture being detected at a location of an input component. That is, in some examples, user 120 may use a “touch and talk” mechanism to provide input. For example, in the example of FIG. 1, the indication of natural language request 117 may be received in response to a tactile event (e.g., user 120 pressing down with their finger) being detected at location 121 on GUI 116, which may cause another input component (e.g., a microphone included in computing device 112) to capture and/or record natural language request 117. In some examples, responsive to receiving an indication of natural language request 117, user interface generator module 108 may apply machine learning module 110, which may include a language model configured to perform natural language processing techniques, to the indication of natural language request 117 to determine at least one user intent. In general, machine learning module 110 may parse through input including any amount of data, i.e., machine learning module 110 may identify any number of user intents in an indication of a natural language input. In some examples, machine learning module 110 may determine explicit and/or implicit intent. That is, in some examples, user interface generator module 108 may also use the information retrieved by API module 106 to interpret and understand an indication of a natural language request. For example, based on example natural language request 117, machine learning module 110 may determine user 120's explicit intent is to create a widget that only displays texts received from a select few contacts. Based on user 120's stored context information, though, machine learning module 110 may determine user 120's implicit intent is to create a widget that only displays texts received from family members via a specific messaging application.

Furthermore, machine learning module 110 may parse through stored context information for user 120 to identify any information that can be used to generate widgets for satisfying the at least one identified user intent. In some examples, user interface generator module 108 may determine, for the at least one user intent, at least one associated application installed at computing device 112. For example, in some examples, the at least one user intent may be considered a task, and the at least one associated application may include one or more functions for performing the task. In some examples, user interface generator module 108 may use at least a portion of the retrieved information to contextualize other portions of the retrieved information.

Thus, in general, user interface generator module 108 may generate, using one or more of the information from the one or more applications and the context information for the user, a set of instructions including instructions for generating at least one graphical component to satisfy the at least one user intent. In some examples, after a user provides a natural language request, and prior to computing device 112 receiving the instructions from computing system 100, one or more visual effects may be displayed on GUI 116, e.g., to indicate to the user that the system is currently processing input and/or generating output. For example, GUI 116 may display a pattern, such that a user may understand when the graphical component generation process is occurring, and/or to temper long latencies. In general, user interface generator module 108 may also generate instructions for layout responsiveness to UI generation. In some examples, GUI 116 may dynamically adapt to different screen sizes, orientations, device specifications, etc., may adapt to fit generated widgets within a single frame or screen, etc.

Continuing the example above, user interface generator module 108 may use, for example, information from a messaging application and context information for user 120 that indicates which contacts are associated with user 120's family members to generate instructions. In this example, the instructions may be instructions for generating a custom widget for display on GUI 116 (e.g., the custom widget may be represented by one of widgets 118A-118I), in which the custom widget only displays texts received from family members. In the example of FIG. 1, widgets 118 are shown as generic graphical components for simplicity, but in general, may display various information, may provide various functionality, may include various sizes, shapes, colors, designs, positioning, etc. As such, a custom widget may be generated based on user 120's intent, such that the custom widget provides the functionality, displays the information, etc. required to satisfy user 120's intent. Furthermore, the custom widget may be generated based on user 120's context information that indicates user 120's preferences for widget size, shape, color, design, position, etc.

As such, the techniques described in this disclosure may enable users to create custom widgets according to a user's specific intent and personal preferences, such that users may create hyper-personalized user interfaces, e.g., on the home screen and/or lock screen of their personal devices. By creating personal context information for a user, computing system 100 may infer user intent with greater accuracy, and by using this personal context information when generating widgets, computing system 100 may generate widgets that are more attuned to a user's preferences. Furthermore, the generated widgets may provide shortcuts to applications and/or device functionality, which may help users perform tasks and/or receive information in a more efficient manner. In this way, the techniques described in this disclosure may further improve user experience and interaction with personal devices.

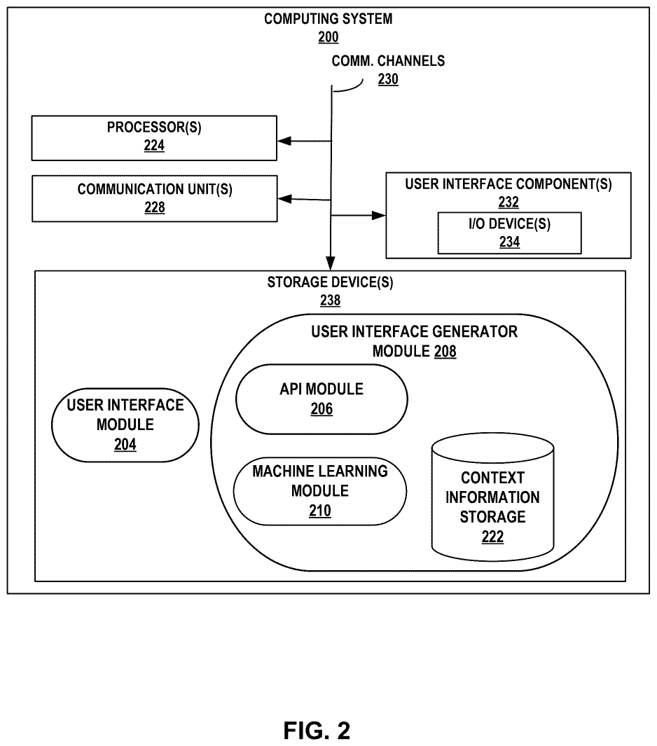

FIG. 2 is a block diagram illustrating another example computing system configured to apply a machine learning module to retrieved information to dynamically generate custom graphical components, in accordance with one or more techniques of this disclosure.

As shown in the example of FIG. 2, computing system 200 includes processors 224, one or more communication channels 230, one or more user interface components (UIC) 232, one or more communication units 228, and one or more storage devices 238. Storage devices 238 of computing system 200 may include user interface module 204, and user interface generator module 208. As shown in the example of FIG. 2, user interface generator module 208 further includes API module 206, machine learning module 210, and context information storage 222.

Some or all of the components and/or functionality attributed to computing system 200 may be implemented or performed by a computing device that may be in communication with computing system 200. In other examples, computing system 200 may be considered a computing device, such as a user computing device (e.g., a mobile phone). Computing system 200, user interface module 204, user interface generator module 208, API module 206, machine learning module 210, and user interface (UI) components 202 may be similar if not substantially similar to computing system 100, user interface module 104, user interface generator module 108, API module 106, machine learning module 110, and user interface (UI) components 102 of FIG. 1, respectively.

The one or more communication units 228 of computing system 200, for example, may communicate with external devices by transmitting and/or receiving data at computing system 200, such as to and from remote computer systems or computing devices. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection), one or more inter-process communication data structures, or any other components for communicating data between hardware and/or software locally or remotely.

One or more I/O devices 234 of computing system 200 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

User interface module 204, user interface generator module 208, API module 206, machine learning module 210, and context information storage 222 (hereinafter “modules 204-222”) may perform operations described herein using software, hardware, firmware, or a mixture of hardware, software, and firmware residing in and executing on computing system 200 or at one or more other computing devices (e.g., a cloud-based application—not shown). For example, some or all of modules 204-222 may be included in and executable on a local computing device, such as computing device 112 of FIG. 1. As such, the techniques described herein may all be implemented locally on a computing device.

Computing system 200 may execute one or more of modules 204-222, with one or more processors 224 or may execute any or part of one or more of modules 204-222 as or within a virtual machine executing on underlying hardware. One or more of modules 204-222 may be implemented in various ways, for example, as a downloadable or pre-installed application, remotely as a cloud application, or as part of the operating system of computing system 200. Other examples of computing system 200 that implement techniques of this disclosure may include additional components not shown in FIG. 2.

In the example of FIG. 2, one or more processors 224 may implement functionality and/or execute instructions within computing system 200. For example, one or more processors 224 may receive and execute instructions that provide the functionality of UIC 232, communication units 228, one or more storage devices 238 and an operating system to perform one or more operations as described herein. For example, one or more processors 224 may receive and execute instructions that provide the functionality of some or all of modules 204-222 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing system 200 may store information, such as information retrieved from a user computing device, or other data discussed herein, for processing during the operation of computing system 200. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules 204-222 of FIG. 2.

In general, with explicit consent from a user, computing system 200 may retrieve, using API module 206, information from one or more applications, systems, modules, files, data stores, cloud services, etc. included in and/or associated with computing system 200, and/or included in and/or associated with computing device(s) in communication with computing system 200. For example, the information may be retrieved from one or more installed applications, operating system(s), hardware modules, system settings and preferences, system logs and diagnostic tools, configuration files, metadata, associated cloud services, and the like. As such, the information (retrieved with explicit user consent) may include, but is not limited to, application data, application usage data, application permissions, user data, user preference data, user feedback data, location data, system data, device data, network information, connectivity information, device battery data, sensor data, environmental data, time data, event data, notification data, and security data. The retrieved information may be referred to herein as “input data” that may be processed, stored, analyzed, transformed, etc. by computing system 200, e.g., by machine learning module 210.

UI module 204 may receive information and instructions from one or more associated platforms, operating systems, applications, and/or services executing at the computing device (e.g., user interface generator module 208) for generating one or more files each comprising a set of instructions. In some examples, a set of instructions may include instructions for generating at least one graphical component, e.g., a widget. In some examples, UI module 204 may act as an intermediary between the one or more associated platforms, operating systems, applications, and/or services executing at the computing device and various output devices of the computing device (e.g., speakers, LED indicators, vibrators, etc.) to produce output (e.g., graphical, audible, tactile, etc.) with the computing device.

In some examples, user interface generator module 208 may be implemented on a computing device in various ways. For example, user interface generator module 208 may be implemented as a downloadable or pre-installed application or “app.” In another example, user interface generator module 208 may be implemented as part of an operating system of a computing device.

Context information storage 222 is a storage repository that may store, with explicit user consent, information retrieved by API module 206, and/or context information retrieved and/or generated by computing system 200. In general, the retrieved information may include API response data. For example, the information may be retrieved from one or more applications, in which the context information may include information associated with user data, and/or one or more functions included in the one or more applications, e.g., the statically defined capabilities or features of an application. In some examples, the information may additionally or alternatively include system data, environmental data, time data (e.g., when data is received by an application, timestamped data, etc.), event data, notification data (e.g., notifications generated by an application), security data, application and/or device metadata, etc. Information may be stored in context information storage 222 for use by other modules of user interface generator module 208, such as machine learning module 210. As an example, machine learning module 210, which may include a large language model, may analyze at least a portion of the information retrieved by API module 206 to infer one or more user preferences, user data, user behavior, etc. That is, the context information for a user may be defined as or otherwise include one or more of inferred user preferences, inferred user data, inferred user behavior, etc. For example, machine learning module 210 may analyze information retrieved from one or more applications to infer an average font size that the user prefers for displayed text. As another example, machine learning module 210 may analyze information retrieved from a device settings application, e.g., system-level information, to infer a user's preferences for notifications. As another example, machine learning module 210 may analyze information retrieved from a device settings application to infer a user's preferences for device flashlight brightness. As another example, machine learning module 210 may analyze information retrieved from one or more applications to infer which contacts are associated with a user's family members (e.g., based on the user's last name matching the last names of the contacts, and/or contact names such as “Mom,” “Dad,” “Brother,” “Sister,” etc.). As such, in general, user interface generator module 208 may generate context information for a user based on at least a portion of the information retrieved by API module 206, which may be stored in context information storage 222.

In some examples, context information storage 222 may operate, at least in part, as a cache for information retrieved from a computing device (e.g., using one or more communication units 228) or other computing devices. In general, context information storage 222 may be configured as a database, flat file, table, or other data structure stored within storage device 238. In some examples, context information storage 222 is shared between various modules executing at computing system 200 (e.g., between one or more of modules 204-222 or other modules not shown in FIG. 2). In other examples, a different data repository is configured for a module executing at computing system 200 that requires a data repository. Each data repository may be configured and managed by different modules and may store data in a different manner. In some examples, computing system 200 may generate information, such as the context information for the user, and may store the information over a specified period of time. In some examples, information stored in context information storage 222, such as the context information for the user, may be updated, e.g., periodically, when computing system 200 receives feedback regarding output generated by computing system 200, when computing system 200 receives updated information, when machine learning module 210 infers new or updated information, etc.

In general, machine learning module 210 may be configured to interpret input data, such as information and/or indications of natural language input received or retrieved by computing system 200, to identify user intent. The retrieved information may be in various data formats that may or may not be readable to machine learning module 210 (e.g., a language model included in machine learning module 210). In some examples, the retrieved context information may be in data formats including, but not limited to, JavaScript Object Notation (JSON), extensible Markup Language (XML), Ain′t Markup Language (YAML), INI files, plain text, Comma-Separated Values (CSV), Structured Query Language (SQL), and Non-Structured Query Language (NoSQL). In some examples, the information may be in binary formats, database records, highly specialized formats, etc. that may not be immediately readable to machine learning module 210. In these examples, the information may be converted, manipulated, transformed, etc. into a readable format, such as structured or semi-structured text, and/or metadata may be used to interpret the information. For example, machine learning module 210 may convert any input or information to XML, or other structured text types, such as, but not limited to, HTML, JSON, CSV, INI Files, etc. In this way, the information and any other input received by user interface generator module 208 can be provided to machine learning module 210 in a standardized and/or readable format. Furthermore, in some examples, machine learning module 210 may determine the type of information to include in the structured text representation. More specifically, machine learning module 210 may analyze various application functionality, capabilities, and attributes included in the information stored in context information storage 222, such as content descriptions, roles, states, actions, and/or other relevant properties of user interface elements.

As such, in some examples, the retrieved information may be preprocessed. Preprocessing techniques may include extracting one or more additional features from raw data. For example, feature extraction techniques may be applied to the user input or retrieved instructions to generate one or more new, additional features.

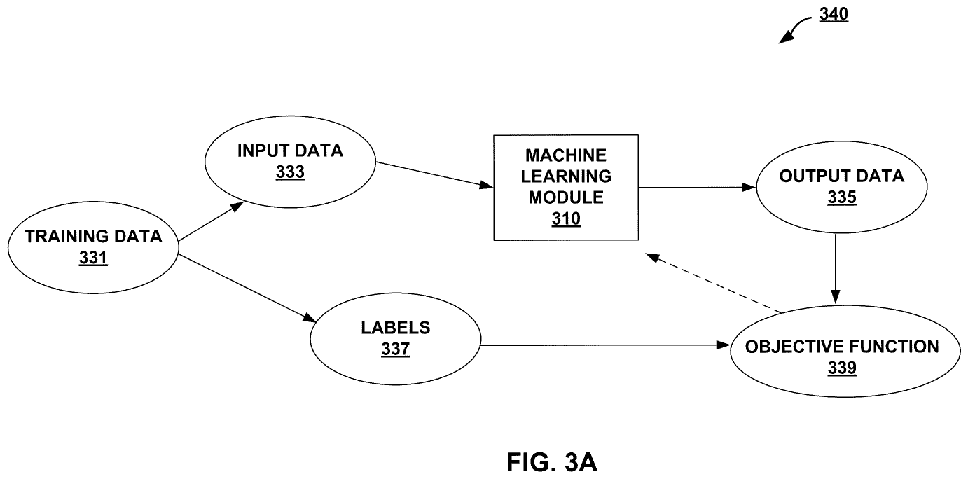

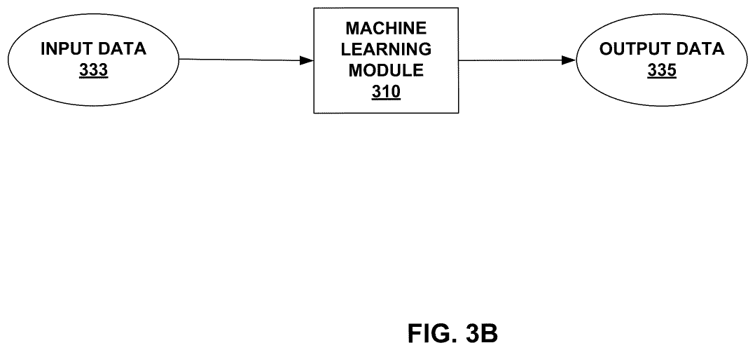

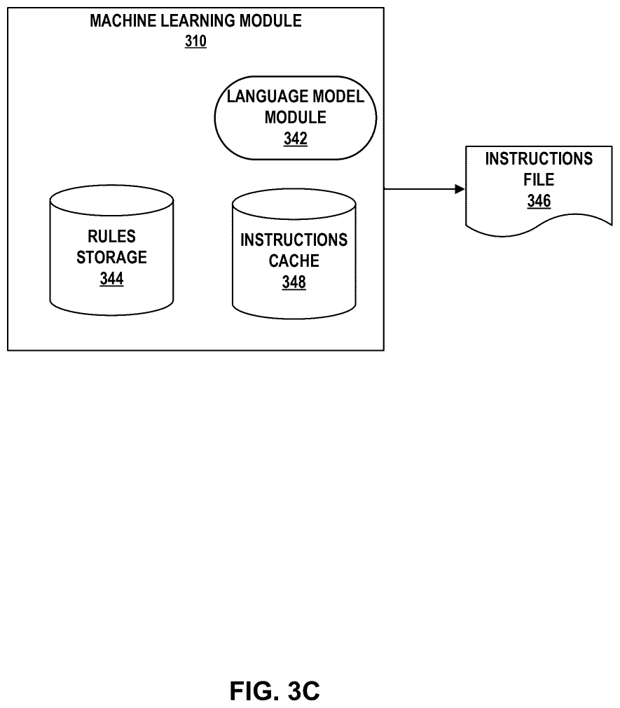

In general, machine learning module 210 may employ a large language model (LLM) that can interpret information and/or indications of natural language input received or retrieved by computing system 200 to identify user intent. In some examples, machine learning module 210 may implement other machine-learned models that may be used in place of or in conjunction with an LLM model, such as those described with respect to FIGS. 3A, 3B, and 3C. Machine learning module 210 may employ an LLM that can infer various types of indications of natural language input (e.g., natural language text retrieved from a messaging application, a natural language speech, etc.).

In some examples, machine learning module 210 may analyze the information to interpret and understand the functionality included in computing system 200 and/or included in a device in communication with computing system 200, so as to determine applications relevant to a user's request, etc. That is, in some examples, user interface generator module 208 may determine, based on the retrieved information, that a user's computing device includes various applications that provide functions for performing various tasks, displaying various information, etc. As such, in some examples, interface generator module 208 may determine, based on at least one identified user intent and information stored in context information storage 222, one or more associated applications, in which each of the one or more associated applications includes one or more functions required to satisfy a user intent, e.g., one or more functions required to perform a task. In general, machine learning module 210 may analyze portions of the retrieved information to interpret and understand other portions of the retrieved information, user intent, and/or stored user context information.

As an example, machine learning module 210 may determine, based on an indication of a natural language request such as, “Create a widget that only shows me texts received from important people,” that a user's intent is to create a widget that only displays text messages received from the user's family members via a specific messaging application. machine learning module 210 may determine this example intent based on information stored in context information storage 222, such as information that indicates a messaging application installed at the user's computing device includes functionality for Short Message Service (SMS) messaging, information that indicates which contacts a user most frequently responds to, information that indicates which of those contacts are associated with the user's family members, etc.

In accordance with the techniques of this disclosure, user interface generator module 208 may generate, using the information stored in context information storage 222, a set of instructions including instructions for generating at least one graphical component based on the at least one user intent. In some examples, user interface generator module 208 provides the instructions to user interface module 204, in which user interface module 204 may generate at least one file comprising the set of instructions. User interface module 204 may send, to a computing device in communication with computing system 200, the at least one file comprising the set of instructions.

The techniques of the present disclosure may be implemented by or otherwise executed on one or more computing devices (e.g., computing device 112 of FIG. 1). Examples of such computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof. Computing system 200 and/or a computing device that implements machine learning module 210 or other aspects of the present disclosure may include a number of hardware components that enable the performance of the techniques described herein.

In general, the techniques described herein may be used to dynamically generate graphical components that serve various purposes, e.g., to provide functionality for performing various tasks in a shortcut manner, to display various information, etc. For example, by generating graphical components that only display a user's desired information, the techniques described herein may prevent users from having to navigate through multiple user interfaces of multiple applications to access such information, and instead may view the information easily on their home screen. Furthermore, the graphical components may be generated based on stored context information for a user, e.g., a personal memory for a user, and thus may be customized or tailored to a user's unique preferences and needs. In this way, the techniques described herein may improve user experience when interacting with personal devices.

FIG. 3A is a conceptual diagram illustrating an example training process for a machine learning module, in accordance with one or more techniques of this disclosure. In some examples, computing device 112 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 described herein can be trained at a training computing system, and then provided for storage and/or implementation at one or more computing devices, such as computing device 112 of FIG. 1. In some examples, training process 340 executes locally at computing system 100 of FIG. 1. However in some examples, training process 340 can be included in or separate from any computing system that implements machine learning module 310.

In general, machine learning module 310 may be or include one or more inference models, i.e., one or more trained machine learning models that can be used to make predictions based on new, unseen data. Machine learning module 310 may “infer” conclusions or outputs, which may be predictions, classifications, recommendations, or other types of decision-making. Machine learning module 310 may be trained according to one or more of various different training types or techniques. For example, in some examples, machine learning module 310 may be trained by training process 340 of FIG. 3A.

As further shown in the example of FIG. 3A, in some examples, machine learning module 310 may be trained on training data 331 that may include input data 333 that has labels 337. The training process shown in FIG. 3A is one example training process; other training processes may be used as well. In general, during training process 340, machine learning module 310 may learn patterns from training data 331, and training process 340 may optimize parameters for machine learning module 310 to minimize prediction errors.

Training data 331 can include, upon user permission for use of such data for training, anonymized usage logs of sharing flows, e.g., content items that were shared together, bundled content pieces already identified as belonging together, e.g., from entities in a knowledge graph, etc. In some examples, training data 331 can include examples of input data 333 that have been assigned labels 337 that correspond to output data 335.

In some examples, machine learning module 310 can be trained by optimizing an objective function, such as objective function 339. For example, in some examples, objective function 339 may be or include a loss function that compares (e.g., determines a difference between) output data generated by the model from the training data and labels (e.g., ground-truth labels) associated with the training data. For example, the loss function can evaluate a sum or mean of squared differences between output data 335 and the labels. In some examples, objective function 339 may be or include a cost function that describes a cost of a certain outcome or output data. Other examples of objective function 339 can include margin-based techniques such as, for example, triplet loss or maximum-margin training.

One or more of various optimization techniques can be performed to optimize objective function 339. For example, the optimization technique(s) can minimize or maximize objective function 339. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some examples, backward propagation of errors can be used in conjunction with an optimization technique (e.g., gradient based techniques) to train machine learning module 310 (e.g., when a machine-learned model is a multi-layer model such as an artificial neural network). For example, an iterative cycle of propagation and model parameter (e.g., weights) update can be performed to train machine learning module 310. Example backpropagation techniques include truncated backpropagation through time, Levenberg-Marquardt backpropagation, etc.

In some examples, machine learning module 310 described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

Machine learning module 310 can be trained using semi-supervised techniques which combine aspects of supervised learning and unsupervised learning. Machine learning module 310 can be trained or otherwise generated through evolutionary techniques or genetic algorithms. In some examples, machine learning module 310 described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some examples, one or more generalization techniques can be performed during training to improve the generalization of machine learning module 310. Generalization techniques can help reduce overfitting of machine learning module 310 to the training data. Example generalization techniques include dropout techniques; weight decay techniques; batch normalization; early stopping; subset selection; stepwise selection; etc.

In some examples, machine learning module 310 described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some examples, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some examples, transfer learning techniques can be used to provide an initial model from which to begin training of machine learning module 310 described herein. In some examples, transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

In some examples, machine learning module 310 may be trained in an offline fashion or an online fashion. In offline training (also known as batch learning), machine learning module 310 is trained on the entirety of a static set of training data. In online learning, machine learning module 310 is continuously trained (or re-trained) as new training data becomes available (e.g., while the model is used to perform inference).

In some examples, training process 340 may involve centralized training of machine learning module 310 (e.g., based on a centrally stored dataset). In other implementations, decentralized training techniques such as distributed training, federated learning, or the like can be used to train, update, or personalize machine learning module 310.

Machine learning module 310 described herein can be trained according to one or more of various different training types or techniques. For example, in some examples, machine learning module 310 can be trained by training process 340 using supervised learning, in which machine learning module 310 is trained on a training dataset that includes instances or examples that have labels. The labels can be manually applied by experts, generated through crowd-sourcing, or provided by other techniques (e.g., by physics-based or complex mathematical models). In some examples, if the user has provided consent, the training examples can be provided by the user computing device. In some examples, this process can be referred to as personalizing the model.

In some examples, machine learning module 310 includes a language model that may be trained (e.g., pre-trained, fine-tuned, etc.) by training process 340. For example, training process 340 may pre-train a language model on a large and diverse corpus of text. As such, in some examples, training data 331 may include a dataset that covers a wide range of topics and domains to ensure machine learning module 310 learns diverse linguistic patterns and contextual relationships. Training process 340 may train a language model to optimize objective function 339. Objective function 339 may be or include a loss function, such as cross-entropy loss, that compares (e.g., determines a difference between) output data generated by the model from training data 331 and labels 337 (e.g., ground-truth labels) associated with training data 331. For example, objective function 339 for a language model may be to correctly predict the next word in a sequence of words or correctly fill in missing words as much as possible.

In some examples, training process 340 may use techniques such low-rank adaptation (LoRA) to train or fine-tune language models (LLMs) implemented by machine learning module 310. In general, LoRA may reduce the number of trainable parameters by freezing pre-trained weights of an LLM and injecting small, trainable low-rank matrices that adapt the model for specific tasks. LoRa may be useful when a model needs to be adapted to multiple tasks with limited task-specific data. That is, training process 340 may use LoRA for task-specific fine-tuning. In some examples, training process 340 may use techniques such as retrieval-augmented generation (RAG), which is a hybrid framework that combines information retrieval with text generation. RAG may be used to fine-tune a generative model implemented by machine learning module 310 by retrieving relevant information from an external database or dataset (e.g., a large and diverse corpus of text) and using that information to generate output that is more accurate and informative. RAG may be useful for generating more factually accurate and contextually relevant summaries and responses to questions.

In some examples, training process 340 may continuously or periodically train a language model included in machine learning module 310. In some examples, training process 340 may fine-tune a language model by using feedback in the training process. For example, UI component 202 of FIG. 2 may receive a user input via a computing device that selects feedback (e.g., thumbs up, thumbs down, etc.) relating to the generated application functionality and associated GUIs that are presented to the user on the computing device. In some examples, the feedback may indicate whether the generated application functionality and associated GUIs are accurate or inaccurate, correct or incorrect, high quality or low quality, etc. UI module 204 may receive this feedback and may send it to user interface generator module 208. User interface generator module 208 may transmit the feedback to machine learning module 310 (specifically to training process 340), in which training process 340 uses the feedback for training. For example, training process 340 may convert the feedback into labeled data for supervised training. Additionally or alternatively, training process 340 may fine-tune a language model by monitoring the relationship between the performance of the language model and user feedback, and iterate the fine-tuning process as necessary (e.g., to receive more positive user feedback and less negative user feedback). In this way, the techniques of this disclosure may establish a feedback loop that continuously improves the quality of output data 335 (e.g., an instructions file) of a language model.

FIG. 3B is a conceptual diagram illustrating an example trained machine learning module, in accordance with one or more techniques of this disclosure. In some examples, computing device 112 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 of FIG. 3B may be trained at a computing system, such as computing system 100 of FIG. 1, and then provided for storage and/or implementation at one or more computing devices, such as computing device 112 of FIG. 1. In some examples, machine learning module 310 executes locally at computing system 100 of FIG. 1. In some examples, computing system 100 may perform machine learning as a service.

As illustrated in FIG. 3B, in some examples, machine learning module 310 is trained (e.g., via training process 340 of FIG. 3A) to receive input data 333, which may be of one or more types and, in response, provide output data 335, which may be of one or more types. Thus, FIG. 3B illustrates machine learning module 310 performing inference, in which machine learning module 310 may use learned patterns to make predictions or decisions on new data, e.g., input data 333. Machine learning module 310 may include one or more machine-learned models trained by training process 340 of FIG. 3A.

Input data 333 may include one or more features that are associated with an instance or an example. In some examples, the one or more features associated with the instance or example can be organized into a feature vector. In some examples, output data 335 can include one or more predictions. Predictions can also be referred to as inferences. Thus, given features associated with a particular instance, machine learning module 310 can output a prediction for such instance based on the features.

Machine learning module 310 can be or include one or more of various different types of machine-learned models. In particular, in some examples, machine learning module 310 may perform NLP tasks. Machine learning module 310 may summarize, translate, or organize input data 333. Machine learning module 310 may use recurrent neural networks (RNNs) and/or transformer models (self-attention models). Example models may include, but are not limited to, GPT-3, BERT, Gemini (e.g., Gemini Ultra, Gemini Pro, Gemini Flash, Gemini Nano), Android AICore, and T5. In some examples, machine learning module 310 may perform classification, summarization, name generation, regression, clustering, anomaly detection, recommendation generation, and/or other tasks.

In some examples, machine learning module 310 can perform various types of classification based on input data 333. For example, machine learning module 310 can perform binary classification or multiclass classification. In binary classification, output data 335 can include a classification of input data 333 into one of two different classes. In multiclass classification, output data 335 can include a classification of input data 333 into one (or more) of more than two classes. The classifications can be single label or multi-label. Machine learning module 310 may perform discrete categorical classification in which input data 333 is simply classified into one or more classes or categories.

In some examples, machine learning module 310 can perform classification in which machine learning module 310 provides, for each of one or more classes, a numerical value descriptive of a degree to which it is believed that input data 333 should be classified into the corresponding class. In some instances, the numerical values provided by machine learning module 310 can be referred to as “confidence scores” that are indicative of a respective confidence associated with classification of the input into the respective class. In some examples, the confidence scores can be compared to one or more thresholds to render a discrete categorical prediction. In some examples, only a certain number of classes (e.g., one) with the relatively largest confidence scores can be selected to render a discrete categorical prediction.

Machine learning module 310 may output a probabilistic classification. For example, machine learning module 310 may predict, given a sample input, a probability distribution over a set of classes. Thus, rather than outputting only the most likely class to which the sample input should belong, machine learning module 310 can output, for each class, a probability that the sample input belongs to such class. In some examples, the probability distribution over all possible classes can sum to one. In some examples, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some examples, only a certain number of classes (e.g., one) with the relatively largest predicted probability can be selected to render a discrete categorical prediction.

In cases in which machine learning module 310 performs classification, machine learning module 310 may be trained using supervised learning techniques. For example, machine learning module 310 may be trained on a training dataset that includes training examples labeled as belonging (or not belonging) to one or more classes.

In some examples, machine learning module 310 can perform regression to provide output data in the form of a continuous numeric value. The continuous numeric value can correspond to any number of different metrics or numeric representations, including, for example, currency values, scores, or other numeric representations. As examples, machine learning module 310 can perform linear regression, polynomial regression, or nonlinear regression. As examples, machine learning module 310 can perform simple regression or multiple regression. As described above, in some examples, a Softmax function or other function or layer can be used to squash a set of real values respectively associated with two or more possible classes to a set of real values in the range (0, 1) that sum to one.

Machine learning module 310 may perform various types of clustering. For example, machine learning module 310 can identify one or more previously-defined clusters to which input data 333 most likely corresponds. Machine learning module 310 may identify one or more clusters within input data 333. That is, in instances in which input data 333 includes multiple objects, documents, or other entities, machine learning module 310 can sort the multiple entities included in input data 333 into a number of clusters. In some examples in which machine learning module 310 performs clustering, machine learning module 310 can be trained using unsupervised learning techniques.

Machine learning module 310 may perform anomaly detection or outlier detection. For example, machine learning module 310 can identify input data that does not conform to an expected pattern or other characteristic (e.g., as previously observed from previous input data). As examples, the anomaly detection can be used for fraud detection or system failure detection.

In some examples, machine learning module 310 can provide output data in the form of one or more recommendations. For example, machine learning module 310 can be included in a recommendation system or engine. As an example, given input data that describes previous outcomes for certain entities (e.g., a score, ranking, or rating indicative of an amount of success or enjoyment), machine learning module 310 can output a suggestion or recommendation of one or more additional entities that, based on the previous outcomes, are expected to have a desired outcome (e.g., elicit a score, ranking, or rating indicative of success or enjoyment). As one example, given input data descriptive of a context of a computing device, such as computing device 112 of FIG. 1, a recommendation system can output a suggestion or recommendation of an application that the user might enjoy or wish to download to computing device 112.

Machine learning module 310 may, in some cases, act as an agent within an environment. For example, machine learning module 310 can be trained using reinforcement learning, which will be discussed in further detail below.

In some examples, machine learning module 310 can be a parametric model while, in other implementations, machine learning module 310 can be a non-parametric model. In some examples, machine learning module 310 can be a linear model while, in other implementations, machine learning module 310 can be a non-linear model.

As described above, machine learning module 310 can be or include one or more of various different types of machine-learned models. Examples of such different types of machine-learned models are provided below for illustration. One or more of the example models described below can be used (e.g., combined) to provide output data 335 in response to input data 333. Additional models beyond the example models provided below can be used as well.

In some examples, machine learning module 310 can be or include one or more classifier models such as, for example, linear classification models; quadratic classification models; etc. Machine learning module 310 may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning module 310 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

Machine learning module 310 may be or include one or more kernel machines. In some examples, machine learning module 310 can be or include one or more support vector machines. Machine learning module 310 may be or include one or more instance-based learning models such as, for example, learning vector quantization models; self-organizing map models; locally weighted learning models; etc. In some examples, machine learning module 310 can be or include one or more nearest neighbor models such as, for example, k-nearest neighbor classifications models; k-nearest neighbors regression models; etc. Machine learning module 310 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

In some examples, machine learning module 310 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

Machine learning module 310 can be or include one or more feed forward neural networks. In feed forward networks, the connections between nodes do not form a cycle. For example, each connection can connect a node from an earlier layer to a node from a later layer.

In some instances, machine learning module 310 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of input data 333 sequence to a subsequent portion of input data 333 sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, machine learning module 310 can be or include one or more convolutional neural networks. In some instances, a convolutional neural network can include one or more convolutional layers that perform convolutions over input data using learned filters.

Filters can also be referred to as kernels. Convolutional neural networks can be especially useful for vision problems such as when input data 333 includes imagery such as still images or video. However, convolutional neural networks can also be applied for natural language processing.

In some examples, machine learning module 310 can be or include one or more generative networks such as, for example, generative adversarial networks. Generative networks can be used to generate new data such as new images or other content.

Machine learning module 310 may be or include an autoencoder. In some instances, the aim of an autoencoder is to learn a representation (e.g., a lower-dimensional encoding) for a set of data, typically for the purpose of dimensionality reduction. For example, in some instances, an autoencoder can seek to encode input data 333 and then provide output data that reconstructs input data 333 from the encoding. Recently, the autoencoder concept has become more widely used for learning generative models of data. In some instances, the autoencoder can include additional losses beyond reconstructing input data 333.

Machine learning module 310 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on input data 333. For example, the embedding can be a representation of knowledge abstracted from input data 333 into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings can be useful inputs for downstream models. For example, embeddings can be useful to generalize input data (e.g., search queries) for a downstream model or processing system.

Machine learning module 310 may include one or more clustering models such as, for example, k-means clustering models; k-medians clustering models; expectation maximization models; hierarchical clustering models; etc.

In some examples, machine learning module 310 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, machine learning module 310 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some examples, machine learning module 310 can be an autoregressive model. In some instances, an autoregressive model can specify that output data 335 depends linearly on its own previous values and on a stochastic term. In some instances, an autoregressive model can take the form of a stochastic difference equation. One example of an autoregressive model is WaveNet, which is a generative model for raw audio.

In some examples, machine learning module 310 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example of an ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top level machine-learned model or a heuristic function to combine and/or weight the outputs of the models that form the ensemble.

In some examples, multiple machine-learned models (e.g., that form an ensemble can be linked and trained jointly (e.g., through backpropagation of errors sequentially through the model ensemble). However, in some examples, only a subset (e.g., one) of the jointly trained models is used for inference.

In some examples, machine learning module 310 can be used to preprocess input data 333 for subsequent input into another model. For example, machine learning module 310 can perform dimensionality reduction techniques and embeddings (e.g., matrix factorization, principal components analysis, singular value decomposition, word2vec/GLOVE, and/or related approaches); clustering; and even classification and regression for downstream consumption.

As discussed above, machine learning module 310 can be trained or otherwise configured to receive input data 333 and, in response, provide output data 335. Input data 333 can include different types, forms, or variations of input data. As examples, in various implementations, input data 333 can include features that describe the content (or portion of content) initially selected by the user, e.g., content of user-selected document or image, links pointing to the user selection, links within the user selection relating to other files available on device or cloud, metadata of user selection, etc. Additionally, with user permission, input data 333 includes the context of user usage, either obtained from the app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some examples, machine learning module 310 can receive and use input data 333 in its raw form. In some examples, the raw input data can be preprocessed. Thus, in addition or alternatively to the raw input data, machine learning module 310 can receive and use the preprocessed input data.

In some examples, preprocessing input data 333 can include extracting one or more additional features from the raw input data. For example, feature extraction techniques can be applied to input data 333 to generate one or more new, additional features. Example feature extraction techniques include edge detection; corner detection; blob detection; ridge detection; scale-invariant feature transform; motion detection; optical flow; Hough transform; etc.

In some examples, the extracted features can include or be derived from transformations of input data 333 into other domains and/or dimensions. As an example, the extracted features can include or be derived from transformations of input data 333 into the frequency domain. For example, wavelet transformations and/or fast Fourier transforms can be performed on input data 333 to generate additional features.

In some examples, the extracted features can include statistics calculated from input data 333 or certain portions or dimensions of input data 333. Example statistics include the mode, mean, maximum, minimum, or other metrics of input data 333 or portions thereof.

In some examples, as described above, input data 333 can be sequential in nature. In some instances, the sequential input data can be generated by sampling or otherwise segmenting a stream of input data. As one example, frames can be extracted from a video. In some examples, sequential data can be made non-sequential through summarization.

As another example preprocessing technique, portions of input data 333 can be imputed. For example, additional synthetic input data can be generated through interpolation and/or extrapolation.

As another example preprocessing technique, some or all of input data 333 can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of input data 333 can be normalized by subtracting the mean across a given dimension's feature values from each individual feature value and then dividing by the standard deviation or other metric.

As another example preprocessing technique, some or all or input data 333 can be quantized or discretized. In some cases, qualitative features or variables included in input data 333 can be converted to quantitative features or variables. For example, one hot encoding can be performed.

In some examples, dimensionality reduction techniques can be applied to input data 333 prior to input into machine learning module 310. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, during training, input data 333 can be intentionally deformed in any number of ways to increase model robustness, generalization, or other qualities. Example techniques to deform input data 333 include adding noise; changing color, shade, or hue; magnification; segmentation; amplification; etc.

In response to receipt of input data 333, machine learning module 310 can provide output data 335. Output data 335 can include different types, forms, or variations of output data. As examples, in various implementations, output data 335 can include content, either stored locally on the user device or in the cloud, that is relevantly shareable along with the initial content selection.

As discussed above, in some examples, output data 335 can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, output data 335 can include clustering data, anomaly detection data, recommendation data, or any of the other forms of output data discussed above.

In some examples, output data 335 can influence downstream processes or decision making. As one example, in some examples, output data 335 can be interpreted and/or acted upon by a rules-based regulator.

Any of the different types or forms of input data described herein can be combined with any of the different types or forms of machine-learned models described herein to provide any of the different types or forms of output data described herein.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof. A computing system that implements machine learning module 310 or other aspects of the present disclosure may include a number of hardware components that enable the performance of the techniques described herein.

In some instances, output data 335 obtained through machine learning module 310 at a computing system or device can be used to improve other device tasks or can be used by other non-user devices to improve services performed by or for such other non-user devices. For example, output data 335 can improve other downstream processes performed by a server device for a computing device of a user or embedded computing device. In other instances, output data 335 obtained through implementation of machine learning module 310 at a computing system or device can be sent to and used by a user computing device, an embedded computing device, or some other client device. In some examples, computing system 200 of FIG. 2 may perform machine learning as a service.

In yet other implementations, different respective portions of machine learning module 310 can be stored at and/or implemented by some combination of a user computing device; an embedded computing device; a server computing device; etc. In other words, portions of machine learning module 310 may be distributed in whole or in part amongst a client device (e.g., computing device 112 of FIG. 1) and a computing system (e.g., computing system 100 of FIG. 1).

A computing device such as computing device 112 of FIG. 1 may perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc.

In some examples, multiple instances of machine learning module 310 can be parallelized to provide increased processing throughput. For example, the multiple instances of machine learning module 310 can be parallelized on a single processing device or computing device or parallelized across multiple processing devices or computing devices.

A computing device that implements machine learning module 310 or other aspects of the present disclosure can include a number of hardware components that enable performance of the techniques described herein. For example, a computing device can include one or more memory devices that store some or all of machine learning module 310. For example, machine learning module 310 can be a structured numerical representation that is stored in memory. The one or more memory devices can also include instructions for implementing machine learning module 310 or performing other operations. Example memory devices include RAM, ROM, EEPROM, EPROM, flash memory devices, magnetic disks, etc., and combinations thereof.

A computing device can also include one or more processing devices that implement some or all of machine learning module 310 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

In some examples, machine learning module 310 described herein can be included in different portions of computer-readable code on a computing device. In one example, machine learning module 310 can be included in a particular application or program and used (e.g., exclusively) by such a particular application or program. Thus, in one example, a computing device can include a number of applications and one or more of such applications can contain its own respective machine learning library and machine-learned model(s).

In another example, machine learning module 310 described herein can be included in an operating system of a computing device (e.g., in a central intelligence layer of an operating system) and can be called or otherwise used by one or more applications that interact with the operating system. In some examples, each application can communicate with the central intelligence layer (and model(s) stored therein) using an application programming interface (API) (e.g., a common, public API across all applications).

In some examples, the central intelligence layer can communicate with a central device data layer. The central device data layer can be a centralized repository of data for the computing device. The central device data layer can communicate with a number of other components of the computing device, such as, for example, one or more sensors, a context manager, a device state component, and/or additional components. In some examples, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination.

Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Further to the descriptions above, a user may be provided with controls that enable the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 3C is a conceptual diagram illustrating a machine learning module configured to parse natural language input to identify user intent, in accordance with one or more techniques of this disclosure. Machine learning module 310 of FIG. 3C may be an example of machine learning module 310 of FIGS. 3A and 3B. In general, machine learning module 310 can be or include one or more transformer-based neural networks, such as a language model module 342. In general, language model module 342 may apply an LLM to indications of natural language requests/input to determine at least one user intent. In some examples, language model module 342 may apply an LLM to information retrieved from a user computing device and/or generated user context information to determine information, e.g., user preferences, application functionality, etc. that is relevant to the determined user intent.

Language model module 342 may implement, for example, the Pathways Language Model developed by Google. Transformer-based neural networks may refer to a type of deep learning architecture specifically designed for handling sequential data, such as text or time series. In other words, transformer-based neural networks like LLMs may be configured to perform natural language processing (NLP) tasks, such as question-answering, machine translation, text summarization, and sentiment analysis. Language model module 342 may be configured to perform tasks such as classification, sentiment analysis, entity extraction, extractive question answering, summarization, re-writing text in a different style, ad copy generation, and concept ideation.

Transformer-based neural networks may utilize a self-attention mechanism, which allows the model to weigh the importance of different elements in a given input sequence relative to each other. The self-attention mechanism may help language model module 342 effectively capture long-range dependencies and complex relationships between elements, such as words in a sentence.

Language model module 342 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In some examples, language model module 342 may determine a set of information types included in the input. An information type may be or otherwise include a topic, theme, point, subject, purpose, intent, keyword, etc. In some examples, language model module 342 may determine the information type by leveraging a self-attention mechanism to capture the relationships and dependencies between words in the input sequence. For example, language model module 342 may tokenize (e.g., split) a sequence of words or subwords, which language model module 342 may convert into vectors (e.g., numerical representations) that language model module 342 can process. Language model module 342 may use the self-attention mechanism to weigh the importance of each token in relation to the others. In this way, language model module 342 may identify patterns and relationships between the tokens, and in turn the words corresponding to the tokens, that indicate one or more information types.

In general, language model module 342 may excel at performing NLP tasks, such as generating text and other content (e.g., new code that generates GUIs, graphical components, and/or functionality for performing one or more tasks, i.e., functionality required to satisfy the user intent). However, with respect to specific types of content (e.g., specific information types), language model module 342 may have an increased likelihood of generating false, inaccurate, or bad quality information. To address this issue, language model module 342 may be configured to exclude the generation of content or code relating to a set of excluded information types. For example, the set of excluded information types may include one or more of phone numbers, addresses, web addresses, functionality prohibited by an application, sensitive data (e.g., full bank account information), etc. Thus, input information may be passed in language model module 342 with certain prerequisites, prompts, or “rules” that can be stored in rules storage 344. Machine learning module 310 may apply these prerequisites, prompts, or rules when generating the set of instructions for generating the GUIs and graphical components associated with the functionality for performing the identified tasks.

For example, machine learning module 310 may implement a rule such as, “Do not include user's sensitive information” when generating instructions for generating a widget that provides functionality for transferring funds from the user's bank account to a trusted contact. In some examples, machine learning module 310 may use accessibility information when generating new code for GUIs and graphical components, such that the user can easily interact with the GUIs and graphical components. That is, in some examples, the instructions for generating the widget may be generated according to rules associated with user preferences and/or the information retrieved from the one or more applications. For example, the instructions may be generated according to rules for color schemes, font sizes, amount of displayed text, etc. In some examples, the rules may be text inputs such as, for example, “Do not display more than 25 characters of a message within a widget.” As such, rules storage 354 may store a plurality of text inputs and/or other data that further specify how instructions file 346 should be generated by machine learning module 310. For example, machine learning module 310 may generate instructions file 346 in accordance with the one or more predefined rules stored in rules storage 344, which may include, for example, unauthorized terms, unauthorized class names, unauthorized dimensions of the graphical user interface, unauthorized application functionality, etc. Because language model module 342 can interpret the rules along with the input, the computing system may provide more accurate instructions for generating graphical components that satisfy user intents.

While language model module 342 may be a transformer-based neural network in some examples, in some other examples, language model module 342 may be or otherwise include one or more other types of neural networks. For example, language model module 342 may be or include an autoencoder. In some examples, the aim of an autoencoder is to learn a representation (e.g., a lower-dimensional encoding) for a set of data, typically for the purpose of dimensionality reduction. For example, in some examples, an autoencoder can seek to encode the input data and then provide output data that reconstructs the input data from the encoding. In some examples, the autoencoder can include additional losses beyond reconstructing the input data. Language model module 342 may be or include one or more other forms of artificial neural networks such as, for example, deep Boltzmann machines, deep belief networks, stacked autoencoders, etc. Any of the neural networks described herein can be combined (e.g., stacked) to form more complex networks.

Generally, large language models can be slow and expensive in terms of carbon, energy usage, and financial cost. Thus, in some examples, machine learning module 310 may minimize how often language model module 342 is invoked by caching generated instructions, or new code, in instructions cache 348. For example, in some examples, language model module 342 may use a prompt including the context information retrieved by the computing system. At runtime, more specific details may be gathered (e.g., via the API), such that the generated instructions or code may be reused. Specifically, machine learning module 310 may be configured to perform instruction embedding in which a representation (i.e., embedding) of frequently used or critical instructions are stored in instructions cache 348.

In various examples, instructions file 346 may be generated based on the instructions stored in instructions cache 348 and any additional instructions, information, or updates retrieved by an API module that are not present in instructions cache 348. For example, context information storage 222 of FIG. 2 or any other local memory may store these additional instructions, information, or updates retrieved by API module 206. Machine learning module 310 may query context information storage 222 or other local memory to gather these additional instructions, information, or updates and use them with the cached instructions at runtime to generate instructions file 346. As an example, the instructions for generating a widget with a general format (e.g., size, shape, color) may be stored in instructions cache 348, and may be merged with instructions for generating a widget that provides specific functionality based on a specific user intent. In some examples, instructions cache 348 may store, at least temporarily, instructions for generating the customized widget based on a specific user intent, and may update the instructions based on, e.g., user feedback or additional requests to edit the customized widget. In some examples, some widgets may be updated without additional requests to do so. For example, if a user requests a widget for displaying the current temperature outside, the widget may be updated as needed to display the current temperature. In these examples, instructions cache 348 may store instructions for generating the customized widget that displays a temperature, and when the current temperature is updated, the computing system may generate instructions file 346 including the instructions for generating the widget such that the updated current temperature is displayed. As such, in general, instructions file 346 may include cached instructions and/or additional instructions, information, or updates for generating graphical components.

By storing frequently used or critical instructions in instructions cache 348, machine learning module 310 may reuse the frequently used or critical instructions without having to invoke language model module 342 on data other than what is included in new context information or input (e.g., language model module 342 may not have to re-apply the large language model to all stored context information). In some examples, machine learning module 310 may apply code caching to both compiled and interpreted languages. Machine learning module 310 may implement various types of caching, such as, for example, Just-In-Time (JIT) compilation, Ahead-Of-Time (AOT) compilation, and bytecode caching.

In some examples, instructions file 346 may include all data collected or used by the computing system to generate instructions file 346. For example, instructions file 346 may include details for how the user's natural language was resolved into working code. In some examples, users may be able to view or “inspect” instructions file 346. In other words, a user may be provided various controls to clarify, inspect, or stop a task to ensure that the computing system is following the user's intent. Thus, the generated graphical components may be inspectable, in which users can, for example, interact with widgets to see the associated data, code or instructions (e.g., instructions file 346), or pinch to expand widgets to reveal more controls. Furthermore, a user may be able to edit instructions file 346. For example, a user may edit the parameters used by machine learning module 310, and the code included in instructions file 346 may update to reflect the edits. Furthermore, in some examples, users may interact with the graphical components to add or delete graphical components, directly edit parameters, edit the arrangement of the graphical components, change, add, or delete visual effects, etc. As such, any data included in instructions file 346 may be customizable or user configurable. However, it should be noted that in some examples, certain instructions may not be inspectable and/or editable by users, such as those pertaining to certain graphical elements associated with certain applications (e.g., trademarked logos or symbols), and one or more functions included in the associated applications (e.g., a user may not edit a banking application's functionality for transferring funds).

By leveraging one or more of the machine learning techniques described herein, and by leveraging code caching, the user interface generation provided by the computing system may require less time and/or computational resources to create new and custom graphical components to satisfy user intent.

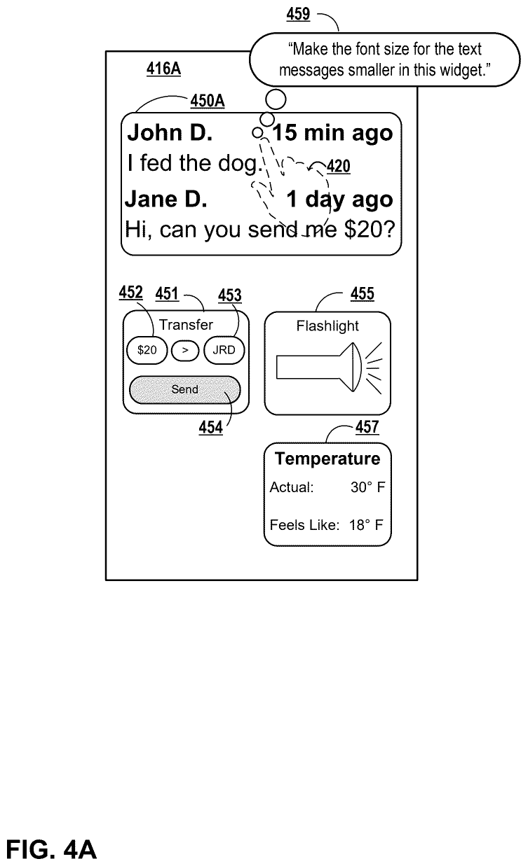

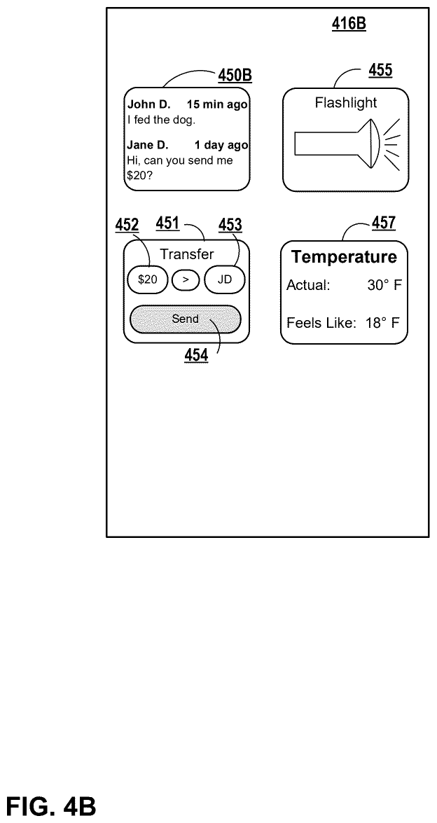

FIGS. 4A-4B are conceptual diagrams illustrating examples of custom graphical components, in accordance with one or more techniques of this disclosure. FIGS. 4A-4B may be described with respect to computing system 100 and computing device 112 of FIG. 1 Some or all of the components and/or functionality attributed to computing system 100 may be implemented or performed by computing device 112. That is, in some examples, the techniques described herein may be implemented or performed locally, e.g., “on-device.”

In the example of FIG. 4A, with explicit consent from user 420 operating computing device 112, user interface generator module 108 may retrieve, using API module 106, information from one or more applications, such as a banking application, web browser application, or any other application that might be installed at computing device 112 (e.g., a mobile phone). In some examples, the information may be retrieved from a device settings application. Thus, in general, the information may include system-level information (e.g., parameters and configurations that govern how computing device 112 operates, such as Wi-Fi, display brightness, notifications settings, etc.), and/or application-level information (e.g., user preferences tied to specific applications, functional data specific to the operations or state of an application, etc.). For example, in the example of FIG. 4A, the information may include information from a messaging application, e.g., a text message received from Jane Doe such as, “Hi, can you send me $20?”, information pertaining to user 420's usage of computing device 112's flashlight, weather information from a web browser application, information from a banking application, e.g., user 420's trusted contacts and current balance, etc.

Computing system 100 may generate, based on at least a portion of the information, context information for user 420. As an example, based on the information retrieved from the messaging application, machine learning module 110 may infer that Jane Doe and John Doe are user 420's family members, e.g., based on information indicating user 420's last name is also “Doe.” As another example, based on the information pertaining to user 420's usage of computing device 112's flashlight, machine learning module 110 may infer that user 420 prefers to use the flashlight with the brightest setting.

In the example of FIG. 4A, GUI 416A (which may be similar if not substantially similar to GUI 116 of FIG. 1) may include custom graphical components, such as widget 450A, widget 451, widget 455, and widget 457. In general, each of widget 450A, widget 451, widget 455, and widget 457 may be generated in response to user 420 providing a natural language request for a custom widget. For example, widget 450A may be generated in response to a natural language request such as, “Create a widget that only shows me texts received from important people.” Widget 451 may be generated in response to a natural language request such as, “Create a widget that quickly lets me send money to Jane.” Widget 455 may be generated in response to a natural language request such as, “Create a widget for the flashlight.” Widget 457 may be generated in response to a natural language request such as, “Create a widget that shows me the actual temperature and what it feels like outside.” Computing system 100 may receive an indication of a natural language request and apply machine learning module 110 to the indication of the natural language request to determine at least one user intent. In some examples, a user may provide multiple requests, e.g., two or more of the example natural language requests above, simultaneously, such as to cause computing system 100 to generate multiple widgets.

In some examples, computing system 100 may apply machine learning module 110 to the at least one user intent to determine a widget type. Example widget types may include, but are not limited to, a first type associated with system-level functionality, a second type associated with application-level functionality, a third type associated with the context information for the user, a fourth type associated with web browser information, and a fifth type associated with generated logic. That is, in some examples, machine learning module 110 may determine a type of widget associated with the user intent, in which each type of widget may require varying amounts and types of information in order to be generated. In some examples, each type of widget may have specific rules for how the widget may be generated. For example, generating instructions for a widget of the first type associated with system-level functionality may have less restrictions on the functionality that the widget can provide, as the system-level functionality may be native to the device. As another example, generating instructions for a widget of the second type associated with application-level functionality may have more restrictions (e.g., restrictions pertaining to the application functionality that can be provided by the widget, trademarked logos or other UI elements, colors, aesthetics, etc.). As another example, generating instructions for a widget of the fourth type associated with web browser information may require the system to frequently or periodically retrieve information from the web browser, such as to keep the widget updated with current and accurate information (e.g., news, weather, etc.).

Continuing the example above, machine learning module 110 may determine, based on the user intent to create a widget that only displays text messages received from user 420's family members, that the widget for this user intent should be of the third type associated with the context information for user 420. That is, machine learning module 110 may determine that the widget for only displaying text messages received from family members should not provide application functionality, but should display information according to the user's context information. Computing system 100 may generate the instructions for generating widget 450A based on the third type, e.g., rules, cached instructions, or other information associated with the third type.

As another example, machine learning module 110 may determine, based on the user intent to create a widget that provides functionality for transferring funds to Jane Doe's account via the banking application, that the widget for this user intent should be of the second type associated with application-level functionality. Computing system 100 may generate the instructions for generating widget 451 based on the second type, e.g., rules, cached instructions, or other information associated with the second type. In some examples, widgets generated based on the second type may trigger application actions, e.g., may provide shortcuts.

As another example, machine learning module 110 may determine, based on the user intent to create a widget for turning computing device 112's flashlight on and off, that the widget for this user intent should be of the first type associated with system-level functionality. Computing system 100 may generate the instructions for generating widget 455 based on the first type, e.g., rules, cached instructions, or other information associated with the first type.

As another example, machine learning module 110 may determine, based on the user intent to create a widget that displays the current temperature and the wind chill temperature for user 420's current location, that the widget for this user intent should be of the fourth type associated with web browser information. Computing system 100 may generate the instructions for generating widget 457 based on the fourth type, e.g., rules, cached instructions, or other information associated with the fourth type. For example, a widget generated based on the fourth type may be configured to display encyclopedic and real-time data retrieved from web searches.

Although not explicitly shown in the example of FIG. 4A, in some examples, a widget may be generated on a fifth type associated with generated logic. In general, “generated logic” may be considered instructions, data, code, etc. dynamically generated by computing system 100. For example, in some examples, a user may provide a request to generate a widget that provides functionality that is not considered to be predefined or statically defined functionality provided by a single application, but may be considered “new” functionality that is based on the predefined or statically defined functionality provided by one or more applications. For example, in some examples, the fifth type may be associated with combined functionality from two or more applications. As an example, a user may provide a request such as, “Create a widget that lets me add text messaged invites to my calendar.” In this example, machine learning module 110 may determine, based on the user intent to create a widget that displays text messages associated with events and lets the user add the events to their calendar application, that the widget for this user intent should be of the fifth type associated with generated logic. Computing system 100 may generate the instructions for generating a widget based on the fifth type, e.g., rules, cached instructions, or other information associated with the fifth type. In this example, computing system 100 may generate instructions for generating a widget that provides functionality from a messaging application (e.g., displaying received text messages) and functionality from a calendar application (e.g., adding events to a calendar).

It should be noted, however, that each widget may still be generated based on at least a portion of a user's context information. For example, while widget 455 and widget 457 may not be considered of the third type associated with the context information for user 420, they may still be generated using at least a portion of the context information for user 420. For example, widget 455 may be generated based on context information indicating the brightness setting that user 420 most frequently operates the flashlight with, the average font size that user 420 prefers for displaying text, user 420's preferred visual aesthetics, etc. Widget 457, for example, may be generated based on context information indicating user 420's current location, the average font size that user 420 prefers for displaying text, user 420's preferred visual aesthetics, etc. In some examples, though, while the one or more widgets may be generated to accommodate a user's unique preferences, additionally or alternatively, the one or more widgets may be generated to visually match brand and/or application aesthetics.

As shown in the example of FIG. 4A, each of widgets 450A, 451, 455, and 457 may display various information and may include various user interface elements. For example, widget 450A, as shown, may include text such as “John D.” to indicate that John D. is the contact from which a first text message was received, “15 min ago,” to indicate when the message from John D. was received, at least a portion of the text message received from John D. (e.g., “I fed the dog.”). As shown, widget 450A may further include text such as “Jane D.” to indicate that Jane D. is the contact from which a second text message was received, “1 day ago,” to indicate when the message from Jane D. was received, at least a portion of the text message received from Jane D. (e.g., “Hi, can you send me $20?”). As another example, widget 457 may display a text header such as “Temperature,” and text such as “Actual: 30° F.,” and “Feels Like: 0° F.” In some examples, a custom graphical component may be considered interactive. For example, widget 455 may include a text header such as “Flashlight” and a flashlight icon, and user 420 may simply interact with widget 455 (e.g., tap widget 455 like a button) to toggle the device flashlight on and off. As another example, widget 451 includes text entry box 452, in which user 420 may input an amount of money they would like to transfer, and text entry box 453, in which user 420 may input a trusted contact that they would like to transfer the money to. In some examples, such as in the example of FIG. 4A, text entry boxes 452 and 453 may be automatically populated based on the user 420's intent. For example, based on the user intent to create a widget that provides functionality for transferring funds to Jane Doe's account via the banking application, and based on other information such as Jane Doe's text message that indicates a request for $20, text entry box 452 may be automatically populated with “$20” and text entry box 453 may be automatically populated with “JRD,” which may be associated with Jane's trusted banking account contact. As shown, widget 451 further includes “Send” button 454, which user 420 may interact with to send, for example, $20 to Jane Doe via the banking application.

In some examples, user 420 may provide one or more indications of additional natural language requests to edit, update, provide feedback for, delete, etc. a custom widget. In some examples, the indication of the additional natural language request may be received in response to at least one gesture being detected at a location of a presence-sensitive display corresponding to a particular widget. That is, user 420 may interact with (e.g., hold down on) a widget, which may cause an input device (e.g., microphone) to capture speech. While holding down on the widget, user 420 may provide a spoken natural language request, which may be captured and/or recorded by the microphone. As an example, in the example of FIG. 4A, user 420 may hold down on widget 450A, and while holding down on widget 450A, may provide a second natural language request 459, which may include a spoken request such as, “Make the font size for the text messages smaller in this widget.”

Computing system 100 may apply machine learning module 110 to the indication of second natural language request 459 to determine user 420's intent to decrease the font size for the text messages displayed within widget 450A. Computing system 100 may then generate a set of instructions including instructions for generating an updated widget that displays the text messages with a smaller font size.

As shown in the example of FIG. 4B, GUI 416 (which may be considered another view of GUI 416A of FIG. 4A) may be updated to include updated widget 450B, which may be an updated version of widget 450A. That is, based on user 420's intent to decrease the font size for the text messages displayed within widget 450A, computing system 100 may generate a set of instructions including instructions for generating updated widget 450B that displays the text messages from John D. and Jane D. with a smaller font size. In some examples, indications of additional natural language requests may be used as feedback for computing system 100, e.g., in training machine learning module 110. In some examples, as shown in the example of FIG. 4B, updated widget 450B may be generated with different dimensions than widget 450A, e.g., to maintain design or layout ratios, etc. That is, in some examples, computing system 100 may intelligently determine, e.g., based on user 420's context information, a design, a positioning, dimensions, etc. for each custom widget, and/or a layout for the custom widgets, such that GUI 416B is aesthetically pleasing to user 420 (e.g., the widgets may be displayed in an organized grid on GUI 416B). In some examples, a physics engine may be used to render UI layouts. In some examples, a layout engine (e.g., a browser engine, rendering engine) may be used to automatically place generated UI into a thoughtful grid system. In some examples, a layout engine may be used to transform HTML documents and/or other resources of a web page into interactive visual representations that may be displayed on GUI 416B.

As such, the techniques described in this disclosure may enable users to create custom widgets according to a user's specific intent. By creating personal context information for a user, the computing system may infer user intent with greater accuracy, and by using this personal context information when generating widgets, the computing system may generate widgets that are more attuned to a user's preferences. Furthermore, the generated widgets may provide shortcuts to applications and/or device functionality, which may help users perform tasks and/or receive information in a more efficient manner. In this way, the techniques described in this disclosure may further improve user experience and interaction with personal devices.

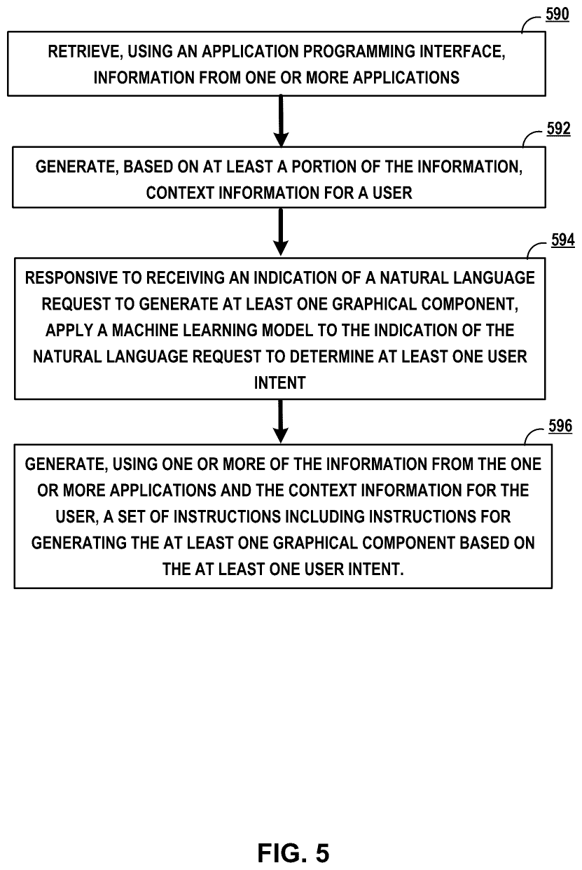

FIG. 5 is a flowchart illustrating an example operation for dynamically generating custom graphical components, in accordance with one or more techniques of this disclosure. The example of FIG. 5 is described with respect to FIGS. 1-4B.

Computing system 100 retrieves, using API module 106, information from one or more applications (590). Computing system 100 generates, based on at least a portion of the information, context information for a user (592). In some examples, computing system 100 applies machine learning module 110 to at least the portion of the information to infer one or more user preferences, and generates the context information for the user, in which the context information for the user includes the one or more user preferences. In some examples, computing system 100 stores the context information for the user in context information storage 222.

In some examples, an indication of natural language request 117 is received in response to at least one gesture being detected at a location of UI components 102. In general, a “natural language” request may refer to an input including formal and/or informal spoken and/or written language, e.g. “colloquial language,” language that people may use in everyday conversations, etc. Responsive to receiving an indication of natural language request 117, computing system 100 applies machine learning module 110 to the indication of natural language request 117 to determine at least one user intent (594). In some examples, machine learning module 110 includes language model module 342, which may be or include a large language model. In some examples, the at least one user intent includes one or more of an explicit user intent and an implicit user intent.

Computing system 100 generates, using one or more of the information from the one or more applications and the context information for the user, instructions file 346 including instructions for generating the at least one graphical component based on the at least one user intent (596). For example, instructions file 346 may include instructions for generating widget 450A. In some examples, the instructions for generating the at least one graphical component are generated according to rules storage 344. In some examples, each rule stored in rules storage 344 is associated with one or more of the one or more user preferences and the information from the one or more applications. In some examples, the at least one graphical component is associated with at least one graphical component type, and the at least one graphical component type is one or more of a first type associated with system-level functionality, a second type associated with application-level functionality, a third type associated with the context information for the user, a fourth type associated with web browser information, and a fifth type associated with generated logic. In some examples, computing system 100 applies machine learning module 110 to the at least one user intent to determine the at least one graphical component type, and generates, based on the at least one graphical component type, instructions file 346 for generating the at least one graphical component.

In some examples, the indication of natural language request 117 is an indication of a first natural language request, the at least one user intent is a first user intent, and responsive to receiving an indication of second natural language request 459, computing system 100 applies machine learning module 110 to the indication of second natural language request 459 to determine a second user intent. In some examples, the indication of second natural language request 459 is received in response to at least one gesture being detected at a location of a presence-sensitive display corresponding to the at least one graphical component. In some examples, the second user intent is indicative of one or more requested edits to the at least one graphical component, and computing system 100 generates instructions file 346 including instructions for generating at least one updated graphical component based on the second user intent. For example, in some examples, the at least one updated graphical component provides functionality required to satisfy the second user intent.

In some examples, the one or more applications are one or more applications executing at computing device 112, in which computing system 100 sends, to computing device 112, instructions file 346.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

This disclosure includes the following examples:

Example 1: A method includes retrieving, by a computing system, and using an application programming interface, information from one or more applications; generating, by the computing system, and based on at least a portion of the information, context information for a user; responsive to receiving an indication of a natural language request to generate at least one graphical component, applying, by the computing system, a machine learning model to the indication of the natural language request to determine at least one user intent; and generating, by the computing system, and using one or more of the information from the one or more applications and the context information for the user, a set of instructions including instructions for generating the at least one graphical component based on the at least one user intent.

Example 2: The method of example 1, wherein the indication of the natural language request is received in response to at least one gesture being detected at a location of an input component.

Example 3: The method of any of examples 1 and 2, wherein generating the context information for the user further comprises: applying, by the computing system, the machine learning model to at least the portion of the information to infer one or more user preferences; generating, by the computing system, the context information for the user, wherein the context information for the user includes the one or more user preferences; and storing, by the computing and in a memory, the context information for the user.

Example 4: The method of example 3, wherein the instructions for generating the at least one graphical component are generated according to a set of rules, and wherein each rule from the set of rules is associated with one or more of: the one or more user preferences, and the information from the one or more applications.

Example 5: The method of any of examples 1 through 4, wherein the indication of the natural language request is an indication of a first natural language request, wherein the at least one user intent is a first user intent, the method further includes responsive to receiving an indication of a second natural language request, applying, by the computing system, the machine learning model to the indication of the second natural language request to determine a second user intent, wherein the second user intent is indicative of one or more requested edits to the at least one graphical component; and generating, by the computing system, a set of instructions including instructions for generating at least one updated graphical component based on the second user intent.

Example 6: The method of example 5, wherein the indication of the second natural language request is received in response to at least one gesture being detected at a location of a presence-sensitive display corresponding to the at least one graphical component.

Example 7: The method of any of examples 1 through 6, wherein the at least one graphical component is associated with at least one graphical component type, wherein the at least one graphical component type is one or more of: a first type associated with system-level functionality, a second type associated with application-level functionality, a third type associated with the context information for the user, a fourth type associated with web browser information, and a fifth type associated with generated logic.

Example 8: The method of example 7, wherein generating the set of instructions including the instructions for generating the at least one graphical component further comprises: applying, by the computing system, the machine learning model to the at least one user intent to determine the at least one graphical component type; and generating, by the computing system, and based on the at least one graphical component type, the instructions for generating the at least one graphical component.

Example 9: The method of any of examples 1 through 8, wherein the machine learning model includes a large language model.

Example 10: The method of any of examples 1 through 9, wherein the at least one user intent includes one or more of an explicit user intent and an implicit user intent.

Example 11: The method of any of examples 1 through 10, wherein the one or more applications are one or more applications executing at a computing device, the method further includes sending, by the computing system and to the computing device, the set of instructions.

Example 12: A computing system includes one or more processors; and one or more storage devices that store instructions, that, when executed by the one or more processors, cause the one or more processors to: retrieve, using an application programming interface, information from one or more applications; generate, based on at least a portion of the information, context information for a user; responsive to receiving an indication of a natural language request to generate at least one graphical component, apply a machine learning model to the indication of the natural language request to determine at least one user intent; and generate, using one or more of the information from the one or more applications and the context information for the user, a set of instructions including instructions for generating the at least one graphical component based on the at least one user intent.

Example 13: The computing system of example 12, wherein the indication of the natural language request is received in response to at least one gesture being detected at a location of an input component.

Example 14: The computing system of any of examples 12 and 13, wherein to generate the context information for the user, the instructions further cause the one or more processors to: apply the machine learning model to at least the portion of the information to infer one or more user preferences; generate the context information for the user, wherein the context information for the user includes the one or more user preferences; and store the context information for the user.

Example 15: The computing system of example 14, wherein the instructions for generating the at least one graphical component are generated according to a set of rules, and wherein each rule from the set of rules is associated with one or more of: the one or more user preferences, and the information from the one or more applications.

Example 16: The computing system of any of examples 12 through 15, wherein the indication of the natural language request is an indication of a first natural language request, wherein the at least one user intent is a first user intent, and wherein the instructions further cause the one or more processors to: responsive to receiving an indication of a second natural language request, apply the machine learning model to the indication of the second natural language request to determine a second user intent, wherein the second user intent is indicative of one or more requested edits to the at least one graphical component; and generate a set of instructions including instructions for generating at least one updated graphical component based on the second user intent.

Example 17: The computing system of example 16, wherein the indication of the second natural language request is received in response to at least one gesture being detected at a location of a presence-sensitive display corresponding to the at least one graphical component.

Example 18: The computing system of any of examples 12 through 17, wherein the at least one graphical component is associated with at least one graphical component type, wherein the at least one graphical component type is one or more of: a first type associated with system-level functionality, a second type associated with application-level functionality, a third type associated with the context information for the user, a fourth type associated with web browser information, and a fifth type associated with generated logic.

Example 19: The computing system of example 18, wherein to generate the set of instructions including the instructions for generating the at least one graphical component, the instructions further cause the one or more processors to: apply the machine learning model to the at least one user intent to determine the at least one graphical component type; and generate, based on the at least one graphical component type, the instructions for generating the at least one graphical component.

Example 20: The computing system of any of examples 12 through 19, wherein the machine learning model includes a large language model.

Example 21: The computing system of any of examples 12 through 20, wherein the at least one user intent includes one or more of an explicit user intent and an implicit user intent.

Example 22: The computing system of example 21, wherein the one or more applications are one or more applications executing at a computing device, wherein the instructions further cause the one or more processors to: send, to the computing device, the set of instructions.

Example 23: A non-transitory computer-readable storage medium encoded with instructions that, when executed by one or more processors, cause one or more processors to: retrieve, using an application programming interface, information from one or more applications; generate, based on at least a portion of the information, context information for a user; responsive to receiving an indication of a natural language request to generate at least one graphical component, apply a machine learning model to the indication of the natural language request to determine at least one user intent; and generate, using one or more of the information from the one or more applications and the context information for the user, a set of instructions including instructions for generating the at least one graphical component based on the at least one user intent.

Example 24: The non-transitory computer-readable storage medium of example 23, wherein the indication of the natural language request is received in response to at least one gesture being detected at a location of an input component.

Example 25: The non-transitory computer-readable storage medium of any of examples 23 and 24, wherein to generate the context information for the user, the instructions further cause the one or more processors to: apply the machine learning model to at least the portion of the information to infer one or more user preferences; generate the context information for the user, wherein the context information for the user includes the one or more user preferences; and store, in the one or more storage devices, the context information for the user.

Example 26: The non-transitory computer-readable storage medium of example 25, wherein the instructions for generating the at least one graphical component are generated according to a set of rules, and wherein each rule from the set of rules is associated with one or more of: the one or more user preferences, and the information from the one or more applications.

Example 27: The non-transitory computer-readable storage medium of any of examples 23 through 26, wherein the indication of the natural language request is an indication of a first natural language request, wherein the at least one user intent is a first user intent, and wherein the instructions further cause the one or more processors to: responsive to receiving an indication of a second natural language request, apply the machine learning model to the indication of the second natural language request to determine a second user intent, wherein the second user intent is indicative of one or more requested edits to the at least one graphical component; and generate a set of instructions including instructions for generating at least one updated graphical component based on the second user intent.

Example 28: The non-transitory computer-readable storage medium of example 27, wherein the indication of the second natural language request is received in response to at least one gesture being detected at a location of a presence-sensitive display corresponding to the at least one graphical component.

Example 29: The non-transitory computer-readable storage medium of any of examples 23 through 28, wherein the at least one graphical component is associated with at least one graphical component type, wherein the at least one graphical component type is one or more of: a first type associated with system-level functionality, a second type associated with application-level functionality, a third type associated with the context information for the user, a fourth type associated with web browser information, and a fifth type associated with generated logic.

Example 30: The non-transitory computer-readable storage medium of example 29, wherein to generate the set of instructions including the instructions for generating the at least one graphical component, the instructions further cause the one or more processors to: apply the machine learning model to the at least one user intent to determine the at least one graphical component type; and generate, based on the at least one graphical component type, the instructions for generating the at least one graphical component.

Example 31: The non-transitory computer-readable storage medium of any of examples 23 through 30, wherein the machine learning model includes a large language model.

Example 32: The non-transitory computer-readable storage medium of any of examples 23 through 31, wherein the at least one user intent includes one or more of an explicit user intent and an implicit user intent.

Example 33: The non-transitory computer-readable storage medium of any of examples 23 through 32, wherein the one or more applications are one or more applications executing at a computing device, wherein the instructions further cause the one or more processors to: send, to the computing device, the set of instructions.

Example 34: A computer program product for generating custom graphical components, the computer program product comprising instructions that, when executed by one or more processors, cause the one or more processors to: retrieve, using an application programming interface, information from one or more applications; generate, based on at least a portion of the information, context information for a user; responsive to receiving an indication of a natural language request to generate at least one graphical component, apply a machine learning model to the indication of the natural language request to determine at least one user intent; and generate, using one or more of the information from the one or more applications and the context information for the user, a set of instructions including instructions for generating the at least one graphical component based on the at least one user intent.

Example 35: The computer program product of example 34, wherein the indication of the natural language request is received in response to at least one gesture being detected at a location of an input component.

Example 36: The computer program product of any of examples 34 and 35, wherein to generate the context information for the user, the instructions further cause the one or more processors to: apply the machine learning model to at least the portion of the information to infer one or more user preferences; generate the context information for the user, wherein the context information for the user includes the one or more user preferences; and store the context information for the user.

Example 37: The computer program product of example 36, wherein the instructions for generating the at least one graphical component are generated according to a set of rules, and wherein each rule from the set of rules is associated with one or more of: the one or more user preferences, and the information from the one or more applications.

Example 38: The computer program product of any of examples 34 through 37, wherein the indication of the natural language request is an indication of a first natural language request, wherein the at least one user intent is a first user intent, and wherein the instructions further cause the one or more processors to: responsive to receiving an indication of a second natural language request, apply the machine learning model to the indication of the second natural language request to determine a second user intent, wherein the second user intent is indicative of one or more requested edits to the at least one graphical component; and generate a set of instructions including instructions for generating at least one updated graphical component based on the second user intent.

Example 39: The computer program product of example 38, wherein the indication of the second natural language request is received in response to at least one gesture being detected at a location of a presence-sensitive display corresponding to the at least one graphical component.

Example 40: The computer program product of any of examples 34 through 39, wherein the at least one graphical component is associated with at least one graphical component type, wherein the at least one graphical component type is one or more of: a first type associated with system-level functionality, a second type associated with application-level functionality, a third type associated with the context information for the user, a fourth type associated with web browser information, and a fifth type associated with generated logic.

Example 41: The computer program product of example 40, wherein to generate the set of instructions including the instructions for generating the at least one graphical component, the instructions further cause the one or more processors to: apply the machine learning model to the at least one user intent to determine the at least one graphical component type; and generate, based on the at least one graphical component type, the instructions for generating the at least one graphical component.

Example 42: The computer program product of any of examples 34 through 41, wherein the machine learning model includes a large language model.

Example 43: The computer program product of any of examples 34 through 42, wherein the at least one user intent includes one or more of an explicit user intent and an implicit user intent.

Example 44: The computer program product of any of examples 34 through 43, wherein the one or more applications are one or more applications executing at a computing device, wherein the instructions further cause the one or more processors to: send, to the computing device, the set of instructions.

Example 45: A computing device comprising: a memory that stores instructions; and one or more processors that execute the instructions to perform the method of any of examples 1-11.

Example 46: An apparatus comprising: means for performing the method of any of examples 1-11.

Various embodiments have been described. These and other embodiments are within the scope of the following claims.

What is claimed is:

1. A method comprising:
retrieving, by a computing system, and using an application programming interface, information from one or more applications;
generating, by the computing system, and based on at least a portion of the information, context information for a user;
responsive to receiving an indication of a natural language request to generate at least one graphical component, applying, by the computing system, a machine learning model to the indication of the natural language request to determine at least one user intent; and
generating, by the computing system, and using one or more of the information from the one or more applications and the context information for the user, a set of instructions including instructions for generating the at least one graphical component based on the at least one user intent.

2. The method of claim 1, wherein the indication of the natural language request is received in response to at least one gesture being detected at a location of an input component.

3. The method of claim 1, wherein generating the context information for the user further comprises:
applying, by the computing system, the machine learning model to at least the portion of the information to infer one or more user preferences;
generating, by the computing system, the context information for the user, wherein the context information for the user includes the one or more user preferences; and
storing, by the computing and in a memory, the context information for the user.

4. The method of claim 3, wherein the instructions for generating the at least one graphical component are generated according to a set of rules, and wherein each rule from the set of rules is associated with one or more of:
the one or more user preferences, and
the information from the one or more applications.

5. The method of claim 1, wherein the indication of the natural language request is an indication of a first natural language request, wherein the at least one user intent is a first user intent, the method further comprising:
responsive to receiving an indication of a second natural language request, applying, by the computing system, the machine learning model to the indication of the second natural language request to determine a second user intent, wherein the second user intent is indicative of one or more requested edits to the at least one graphical component; and
generating, by the computing system, a set of instructions including instructions for generating at least one updated graphical component based on the second user intent.

6. The method of claim 5, wherein the indication of the second natural language request is received in response to at least one gesture being detected at a location of a presence-sensitive display corresponding to the at least one graphical component.

7. The method of claim 1, wherein the at least one graphical component is associated with at least one graphical component type, wherein the at least one graphical component type is one or more of:
a first type associated with system-level functionality,
a second type associated with application-level functionality,
a third type associated with the context information for the user,
a fourth type associated with web browser information, and
a fifth type associated with generated logic.

8. The method of claim 7, wherein generating the set of instructions including the instructions for generating the at least one graphical component further comprises:
applying, by the computing system, the machine learning model to the at least one user intent to determine the at least one graphical component type; and
generating, by the computing system, and based on the at least one graphical component type, the instructions for generating the at least one graphical component.

9. The method of claim 1, wherein the at least one user intent includes one or more of an explicit user intent and an implicit user intent.

10. The method of claim 1, wherein the one or more applications are one or more applications executing at a computing device, the method further comprising:
sending, by the computing system and to the computing device, the set of instructions.

11. A computing system comprising:
one or more processors; and
one or more storage devices that store instructions, that, when executed by the one or more processors, cause the one or more processors to:
retrieve, using an application programming interface, information from one or more applications;
generate, based on at least a portion of the information, context information for a user;
responsive to receiving an indication of a natural language request to generate at least one graphical component, apply a machine learning model to the indication of the natural language request to determine at least one user intent; and
generate, using one or more of the information from the one or more applications and the context information for the user, a set of instructions including instructions for generating the at least one graphical component based on the at least one user intent.

12. The computing system of claim 11, wherein the indication of the natural language request is received in response to at least one gesture being detected at a location of an input component.

13. The computing system of claim 11, wherein to generate the context information for the user, the instructions further cause the one or more processors to:
apply the machine learning model to at least the portion of the information to infer one or more user preferences;
generate the context information for the user, wherein the context information for the user includes the one or more user preferences; and
store the context information for the user.

14. The computing system of claim 13, wherein the instructions for generating the at least one graphical component are generated according to a set of rules, and wherein each rule from the set of rules is associated with one or more of:
the one or more user preferences, and
the information from the one or more applications.

15. The computing system of claim 11, wherein the indication of the natural language request is an indication of a first natural language request, wherein the at least one user intent is a first user intent, and wherein the instructions further cause the one or more processors to:
responsive to receiving an indication of a second natural language request, apply the machine learning model to the indication of the second natural language request to determine a second user intent, wherein the second user intent is indicative of one or more requested edits to the at least one graphical component; and
generate a set of instructions including instructions for generating at least one updated graphical component based on the second user intent.

16. The computing system of claim 15, wherein the indication of the second natural language request is received in response to at least one gesture being detected at a location of a presence-sensitive display corresponding to the at least one graphical component.

17. The computing system of claim 11, wherein the at least one graphical component is associated with at least one graphical component type, wherein the at least one graphical component type is one or more of:
a first type associated with system-level functionality,
a second type associated with application-level functionality,
a third type associated with the context information for the user,
a fourth type associated with web browser information, and
a fifth type associated with generated logic.

18. The computing system of claim 17, wherein to generate the set of instructions including the instructions for generating the at least one graphical component, the instructions further cause the one or more processors to:
apply the machine learning model to the at least one user intent to determine the at least one graphical component type; and
generate, based on the at least one graphical component type, the instructions for generating the at least one graphical component.

19. The computing system of claim 11, wherein the at least one user intent includes one or more of an explicit user intent and an implicit user intent.

20. A non-transitory computer-readable storage medium encoded with instructions that, when executed by one or more processors, cause one or more processors to:
retrieve, using an application programming interface, information from one or more applications;
generate, based on at least a portion of the information, context information for a user;
responsive to receiving an indication of a natural language request to generate at least one graphical component, apply a machine learning model to the indication of the natural language request to determine at least one user intent; and
generate, using one or more of the information from the one or more applications and the context information for the user, a set of instructions including instructions for generating the at least one graphical component based on the at least one user intent.
